(19) United States
(12) Patent Application Publication
(10) Pub. No.: US 2024/0365380 A1
(43) Pub. Date: Oct. 31, 2024

(54) SENSING METHOD, SENSING BY PROXY REQUESTER, AND SENSING BY PROXY RESPONDER

(71) Applicant: GUANGDONG OPPO MOBILE TELECOMMUNICATIONS CORP., LTD., Dongguan (CN)

(72) Inventors: Chaoming LUO, Dongguan (CN); Lei HUANG, Singapore (SG)

(21) Appl. No.: 18/764,605

(22) Filed: Jul. 5, 2024

Related U.S. Application Data
(63) Continuation of application No. PCT/CN2022/070827, filed on Jan. 7, 2022.

(51) Int. Cl. H04W 74/0808; H04W 24/10; H04W 74/08

(52) U.S. Cl. CPC H04W 74/0808; H04W 24/10; H04W 74/0866

(57) ABSTRACT

Provided is a sensing method. The method is applicable to a sensing by proxy (SBP) requester, and includes: transmitting a first request frame to an SBP responder, wherein the first request frame is configured to instruct the SBP responder to establish at least one measurement setup, and the first request frame includes a Sensing Requirement Info field corresponding to a first measurement setup in the at least one measurement setup, wherein the Sensing Requirement Info field is configured for the SBP responder to establish the first measurement setup; and receiving a response frame to the first request frame from the SBP responder.

### CROSS-REFERENCE TO RELATED APPLICATION

This application is a continuation application of International Application No. PCT/CN2022/070827, filed on Jan. 7, 2022, the entire contents of which are incorporated herein by reference.

### TECHNICAL FIELD

Embodiments of the present disclosure relate to the field of communications, and in particular, relate to a sensing method, a sensing by proxy (SBP) requester, and an SBP responder.

### BACKGROUND

Wireless local area network (WLAN) sensing indicates a method and application for sensing a person or object in an environment by detecting changes of a WLAN signal scattered and/or reflected by the person or object.

### SUMMARY

Embodiments of the present disclosure provide a sensing method, an SBP requester, and an SBP responder.

In some embodiments of the present disclosure, a sensing method is provided. The method includes:
transmitting a first request frame to an SBP responder, wherein the first request frame is configured to instruct the SBP responder to establish at least one measurement setup; and
receiving a response frame to the first request frame from the SBP responder.

In some embodiments of the present disclosure, a sensing method is provided. The method includes:
receiving a first request frame from an SBP requester, wherein the first request frame is configured to instruct the SBP responder to establish at least one measurement setup; and
transmitting a response frame to the first request frame to the SBP requester.

In some embodiments of the present disclosure, an SBP requester is provided. The SBP requester is configured to perform the method in the above embodiments or the methods in the embodiments thereof. Specifically, the SBP requester includes a functional module configured to perform the method in the above embodiments or the methods in the embodiments thereof.

In some embodiments, the SBP requester includes a processing unit configured to achieve functions related to the information processing. For example, the processing unit is a processor.

In some embodiments, the SBP requester includes a transmitter unit and/or a receiver unit. The transmitter unit is configured to implement transmission-related functions, and the receiver unit is configured to implement reception-related functions. For example, the transmitter unit is a transmitter, and the receiver unit is a receiver. For example, the SBP requester is a communication chip, the receiver unit is an input circuit or an interface of the communication chip, and the transmitter unit is an output circuit or an interface of the communication chip.

In some embodiments of the present disclosure, an SBP responder is provided. The SBP responder is configured to perform the method in the above embodiments or the methods in the embodiments thereof. Specifically, the SBP responder includes a functional module configured to perform the method in the above embodiments or the methods in the embodiments thereof.

In some embodiments, the SBP responder includes a processing unit configured to achieve functions related to the information processing. For example, the processing unit is a processor.

In some embodiments, the SBP responder includes a transmitter unit and/or a receiver unit. The transmitter unit is configured to implement transmission-related functions, and the receiver unit is configured to implement reception-related functions. For example, the transmitter unit is a transmitter, and the receiver unit is a receiver. For example, the SBP responder is a communication chip, the receiver unit is an input circuit or an interface of the communication chip, and the transmitter unit is an output circuit or an interface of the communication chip.

In some embodiments of the present disclosure, an SBP requester is provided. The SBP requester includes a processor and a memory. The memory is configured to store one or more computer programs, wherein the processor, when loading and running the one or more computer programs stored in the memory, is caused to perform the method in the above embodiments or the methods according to the embodiments thereof.

In some embodiments, one or more processor are configured, and one or more memories are configured.

In some embodiments, the memory and the processor are integrated or disposed separately.

In some embodiments, the SBP requester further includes a transmitter and a receiver.

In some embodiments of the present disclosure, an SBP responder is provided. The SBP responder includes a processor and a memory. The memory is configured to store one or more computer programs, wherein the processor, when loading and running the one or more computer programs stored in the memory, is caused to perform the method in the above embodiments or the methods according to the embodiments thereof.

In some embodiments, one or more processors are configured, and one or more memories are configured.

In some embodiments, the memory and the processor are integrated or arranged separately.

In some embodiments, the SBP requester further includes a transmitter and a receiver.

In some embodiments of the present disclosure, a chip is provided. The chip is configured to perform the method in any of the above embodiments or the methods in the embodiments thereof. Specifically, the chip includes a processor, wherein the processor, when loading and running one or more computer programs in the memory, is caused to perform the method in any of the above embodiments or the methods according to the embodiments thereof.

In some embodiments of the present disclosure, a non-transitory computer-readable storage medium is provided. The non-transitory computer-readable storage medium stores one or more computer programs therein, wherein the one or more computer programs, when loaded and run by a computer, cause the computer to perform the method in any of the above embodiments or the methods according to the embodiments thereof.

In some embodiments of the present disclosure, a computer program product is provided. The computer program product includes computer program instructions, wherein the computer program instructions, when loaded and executed by a computer, cause the computer to perform the method the method in any of the above embodiments or the methods according to the embodiments thereof.

In some embodiments of the present disclosure, a computer program is provided. The computer program, when loaded and run by a computer, causes the computer to perform the method the method in any of the above embodiments or the methods according to the embodiments thereof.

### BRIEF DESCRIPTION OF DRAWINGS

FIG. 1 is a schematic diagram of a communication system architecture according to some embodiments of the present disclosure;

FIG. 2 is a schematic diagram of a station (STA) in a sensing measurement according to some embodiments of the present disclosure;

FIG. 3 is a flowchart of a sensing method according to some embodiments of the present disclosure;

FIG. 4 is a flowchart of a sensing method according to some embodiments of the present disclosure;

FIGS. 5 to 18 are schematic structural diagrams of first request frames according to some embodiments of the present disclosure;

FIGS. 19 to 22 are schematic structural diagrams of response frames to first request frames according to some embodiments of the present disclosure;

FIG. 23 is a schematic structural diagram of an SBP requester according to some embodiments of the present disclosure;

FIG. 24 is a schematic structural diagram of an SBP responder according to some embodiments of the present disclosure;

FIG. 25 is a schematic structural diagram of a communication device according to some embodiments of the present disclosure; and

FIG. 26 is a schematic structural diagram of a chip according to some embodiments of the present disclosure.

### DETAILED DESCRIPTION

The technical solutions of the embodiments of the present disclosure are described hereinafter in combination with the accompanying drawings in the embodiments of the present disclosure. It is obvious that the described embodiments are merely part but not all of the embodiments of the present disclosure. All other embodiments derived by those of ordinary skill in the art without creative efforts based on the embodiments in the present disclosure are within the protection scope of the disclosure.

The technical solutions of the embodiments of the present disclosure are applicable to various communication systems, for example, a wireless local area network (WLAN), a wireless fidelity (Wi-Fi), or other communication systems. The WLAN supports frequency bands including, but not limited to a low frequency band (2.4 GHZ, 5 GHZ, or 6 GHZ), and a high frequency band (60 GHz).

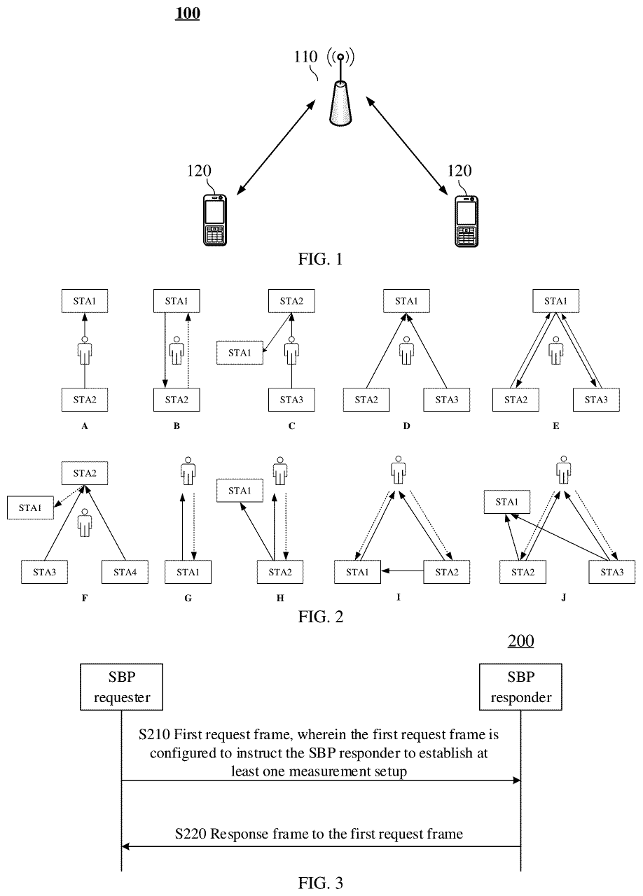

FIG. 1 is a schematic diagram of a communication system architecture according to some embodiments of the present disclosure.

As shown in FIG. 1, the communication system 100 includes an access point (AP) 110 and a STA 120 accessed to the network through the AP 110. In some scenarios, the AP 110 is also referred to as an AP STA. That is, the AP 110 is the AP STA in some way. In some scenarios, the STA 120 is also referred to as a non-AP STA. In some scenarios, the STA 120 includes the AP STA and the non-AP STA. Communications in the communication system 100 include the communication between the AP 110 and the STA 120, the communication between the STA 120 and the STA 120, or the communication between the STA 120 and a peer STA. The peer STA indicates a device communicated with an opposite end of the STA 120. For example, the peer STA is the AP or the non-AP STA.

The AP 110 is a bridge to connect the wired network to the wireless network, and mainly functions as connecting various wireless network clients and accessing the wireless network to the Ethernet. The AP 110 is a terminal device (for example, a mobile phone) including a Wi-Fi chip or a network device (for example, a router).

It should be noted that the function of the STA 120 in the communication system is not absolute, that is, the function of the STA 120 in the communication system is switchable between the AP and the STA. For example, the mobile phone is the STA in the case that the mobile phone is connected to the router, and the mobile phone is the AP in the case that the mobile phone is the hotspot of other mobile phones.

In some embodiments, the AP 110 and the STA 120 are devices applicable to an internet of vehicles, an internet of things (IoT) node or sensor in the IoT, a smart camera, a smart remote control, a smart water meter and the like in the smart home, a sensor in the smart city, and the like.

In some embodiments, the AP 110 is a device that supports an 802.11be format. In some embodiments, the AP is also a device that supports various current and future WLAN formats of the 802.11 family, such as an 802.11ax format, an 802.11ac format, an 802.11n format, an 802.11g format, an 802.11b format, an 802.11a format, and the like. In some embodiments, the STA 120 supports the 802.11be format. In some embodiments, the STA also supports various current and future WLAN formats of the 802.11 family, such as an 802.11ax format, an 802.11ac format, an 802.11n format, an 802.11g format, an 802.11b format, an 802.11a format, and the like.

In some embodiments, the AP 110 and/or the STA 120 are deployed on land, either indoors or outdoors, handheld, wearable or in vehicle, on water (for example, in a ship), in the air (for example, an aircraft, a balloon, a satellite, and the like).

In some embodiments, the STA 120 is a mobile phone, a pad, a computer with a wireless transceiver capability, a virtual reality (VR) device, an augmented reality (AR) device, an industrial control wireless device, a set-top box, a self-driving wireless device, an in-vehicle communication device, a remote medical wireless device, a smart grid wireless device, a transportation safety wireless device, a smart city or smart home wireless device, an in-vehicle communication device, a wireless communication chip/application specific integrated circuit (ASIC)/system on chip (SoC), and the like that support the WLAN/Wi-Fi technologies.

Illustratively, the STA 120 is a wearable device. The wearable device is also referred to as a wearable smart device, which is a generic name of wearable devices intelligently designed and developed for daily wear by the wearable technology, such as glasses, gloves, watches, clothing, shoes, and the like. the wearable device is a portable device that is worn directly on the body or integrated into the clothing or accessories of the user. The wearable device is not only a hardware device, but also achieves powerful functions through software support, data interaction, and cloud interaction. The generalized wearable smart device is full-function and large-sized, achieves all or part of functions without depending on the smart phone, such as smart watches or smart glasses, and the like, and only focus on a type of application functions and is used with other devices such as smart phones, such as smart bracelets and smart jewelry for physical signs monitoring, and the like.

It should be understood that FIG. 1 is only an example of the present disclosure, and should not be constructed as a limitation of the present disclosure. For example, FIG. 1 only illustrates one AP and two STAs. In some embodiments, the communication system 100 includes a plurality of Aps and another number of STAs, which are not limited in the embodiments of the present disclosure.

It should be understood that the device with the communication function in the network/system in the embodiments of the present disclosure is referred to as the communication device. By taking the communication system 100 shown in FIG. 1 as an example, the communication system 100 generally includes the AP 110 and the STA 120 that have the communication function, and the AP 110 and the STA 120 are the specific devices in the above embodiments, which are not repeated herein. The communication system 100 further includes other devices in the communication system 100, for example, a network controller, a gateway, or other network entities, which are not limited in the embodiments of the present disclosure.

It should be understood that the terms “system” and “network” are exchangeable herein. The term “and/or” herein describes associations between associated objects, and indicates three types of relationships. For example, “A and/or B” indicates that A alone, A and B, or B alone. In addition, the character “/” generally indicates that the associated objects are in an “or” relationship.

It should be understood that the term “indicate” in the embodiments of the present disclosure means the direct indication, indirect indication, or an associated relationship. For example, A indicating B means that A directly indicates B, for example, B is acquired by A; A indirectly indicates B, for example, A indicates C and B is acquired by C; A and B are associated.

The terms in the embodiments of the present disclosure are only intended to explain specific embodiments of the present disclosure, rather than to limit the present disclosure. The terms “first,” “second,” “third,” “fourth,” and the like used in the description, claims, and accompanying drawings of the present disclosure are used to distinguish different objects, but not intended to indicate specific order. In addition, the terms “comprise” or “include” and variations thereof are used to cover non-exclusive inclusion.

In the description of the embodiments of the present disclosure, the term “corresponding” mean that there is a direct correspondence or indirect correspondence between two objects, an association relationship between two objects, an indicating and indicated relationship, or a configuring and configured relationship.

In the embodiments of the present disclosure, the “predefinition” or “predetermination” is achieved by pre-storing corresponding codes or forms in the device (for example, including the STA and the network device) or other means for indicating relevant information, and the specific implementations are not limited in the present disclosure. For example, the predefinition is defined in the protocol. Illustratively, the “protocol” indicates standard protocols in the field of communications, for example, the Wi-Fi protocol and related protocols applied to the future Wi-Fi communication system, which are not limited in the present disclosure.

For better understanding of the technical solutions according to the embodiments of the present disclosure, the related terms in the present disclosure are illustrated hereinafter:
association identifier (AID), identifying a terminal associated with an access point;
medium access control (MAC), short for a medium access control address;
transmission opportunity (TXOP), indicating a duration, wherein a terminal having the TXOP initiates one or more transmissions within the duration;
burst, generally indicating a short duration, wherein one or more signals are transmitted within the short duration; and
burst group, indicating a combination of one or more burst signals, wherein burst signals in a same burst group generally have same features.

Sensing measurement indicates sensing a person or object in an environment by detecting changes of a signal scattered and/or reflected by the person or object. That is, the sensing measurement is measuring and sensing the environment by the wireless signal, such that indoor detection of intrusion, movement, fall, and the like, and posture recognition and three-dimensional spatial image construction, and other functions are achieved.

A device in the sensing measurement includes the following roles:
a sensing initiator, a device configured to initiate a sensing session and intend to acquire a sensing result, or referred to as a sensing session initiator;
a sensing responder, a non-sensing initiator device in the sensing session, or referred to as a sensing session responder;
a sensing transmitter, a device configured to initiate a sensing illumination signal, or referred to as a sensing illumination signal transmitter or a sensing signal transmitter;
a sensing receiver, a device configured to receive a sensing illumination signal, or referred to as a sensing illumination signal receiver or a sensing signal receiver;
a sensing processor, a device configured to process a sensing s; and
a sensing participant, including the sensing initiator, the sensing transmitter, and the sensing receiver.

A device may play one or more roles in the sensing measurement. For example, a sensing initiator device functions as a sensing initiator, a sensing transmitter, a sensing receiver, or a sensing transmitter and a sensing receiver. In establishing a sensing session, site devices negotiate sensing roles and operation parameters one by one, or site devices declare their own roles and operation parameters.

FIG. 2 is a schematic diagram of a STA in a sensing measurement according to some embodiments of the present disclosure.

As shown in the part A in FIG. 2, STA1 is a sensing initiator, a sensing receiver, or a sensing processor, and STA2 is a sensing transmitter. As shown in the part B in FIG. 2, the STA1 is a sensing initiator or a sensing transmitter, and STA2 is a sensing receiver or a sensing processor. As shown in the part C in FIG. 2, STA1 is a sensing initiator or a sensing processor, STA2 is a sensing receiver, and STA3 is a sensing transmitter. As shown in the part D in FIG. 2, STA1 is a sensing initiator, a sensing receiver, or a sensing processor, STA2 is a sensing transmitter, and STA3 is a sensing transmitter. As shown in the part E in FIG. 2, STA1 is a sensing initiator, a sensing transmitter, or a sensing processor, STA2 is a sensing receiver, and the STA3 is a sensing receiver. As shown in the part F in FIG. 2, STA1 is a sensing initiator, STA2 is a sensing receiver or a sensing processor, STA3 is a sensing transmitter, and STA4 is a sensing transmitter. As shown in the part G in FIG. 2, STA1 is a sensing initiator, a sensing transmitter, a sensing receiver, or a sensing processor. As shown in the part H in FIG. 2, STA1 is a sensing initiator, and the STA2 is a sensing transmitter, a sensing receiver, or a sensing processor. As shown in the part I in FIG. 2, STA1 is a sensing initiator, a sensing transmitter, a sensing receiver, or a sensing processor, and STA2 is a sensing transmitter or a sensing receiver. As shown in the part J in FIG. 2, STA1 is a sensing initiator or a sensing processor, STA2 is a sensing transmitter or a sensing receiver, and STA3 is a sensing transmitter or a sensing receiver. It should be noted that FIG. 2 is only an example of the present disclosure, and should not be constructed as a limitation of the present disclosure. For example, STA 1, STA 2, and STA 3 in the FIG. 2 only indicate roles of the STA, and a number of the STAs is not limited in the FIG. 2 and following sensing session, measurement, and other processes, for example, roles of STA 1, STA 2, and STA 3 are achieved in one or more STAs.

In some embodiments, a plurality of sensing types are disposed.

For example, a sensing type based on channel state information (CSI), that is, a CSI-based sensing. In the sensing type, a sensing measurement result is acquired by processing the SCI of the received sensing measurement signal. For example, a sensing type based on a reflection signal, that is, a radar-based sensing. In the sensing type, a sensing measurement result is acquired by processing the reflection signal of the received sensing measurement signal.

In some embodiments, the sensing session initiator sets up a plurality of groups of measurement parameters by a measurement setup procedure. The measurement setup includes one group of measurement parameters and is identified by a measurement setup identifier (ID), and is applicable to a plurality of measurements. One measurement is regarded as on measurement instance, and the measurement example is identified by a measurement instance ID.

In detail, a measurement setup is established between a sensing initiator and a sensing responder by a measurement setup procedure, and the measurement setup is identified by a measurement setup identifier. However, with the development of the technologies, a sensing method is required in the field, which can refine and optimize the procedure of establishing the measurement setup to reduce network load and processing complexity.

FIG. 3 is a flowchart of a sensing method 200 according to some embodiments of the present disclosure. The method 200 is performed interactively by an SBP requester and an SBP responder. For example, the SBP requester is an SBP requesting STA, and the SBP responder is an SBP responding STA or an SBP capable sensing initiator. In some embodiments, the SBP responder is an AP.

As shown in FIG. 3, the method 200 includes the following processes.

In S210, an SBP requester transmits a first request frame to an SBP responder, wherein the first request frame is configured to instruct the SBP responder to establish at least one measurement setup.

In S220, the SBP requester receives a response frame to the first request frame from the SBP responder.

In the embodiments, the first request frame is added and is designed to request the SBP responder to establish at least one measurement setup, such that the measurement setups are established by the proxy method. That is, the procedure of establishing the measurement setup is refined and optimized, and the network load, the processing complexity, and the power consumption are reduced.

It should be understood that the specific names of the first request frame and the response frame to the first request frame are not limited in the present disclosure. For example, in some embodiments, the first request frame is also referred to as an SBP request frame, and the response frame to the first request frame is also referred to as an SBP response frame.

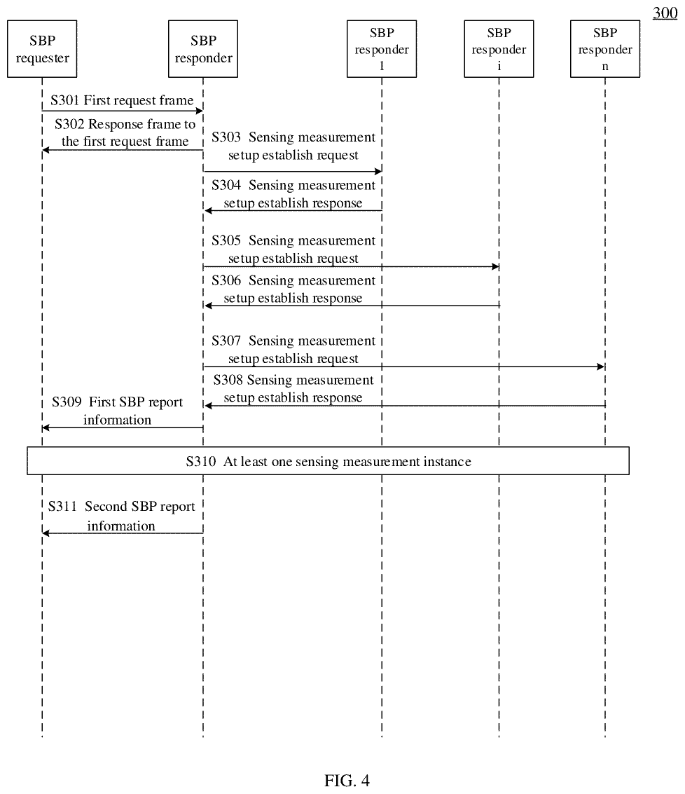

FIG. 4 is a flowchart of a sensing method 300 according to some embodiments of the present disclosure. The method 300 is performed interactively by an SBP requester, an SBP responder, and n sensing responders. For example, the SBP requester is an SBP requesting STA, the SBP responder is an SBP responding STA, and the sensing responder is an SBP capable sensing initiator. In some embodiments, the SBP responder is an AP, the sensing responder is a device capable of establishing the measurement setups with the SBP responder. The SBP requester is a device in the n sensing responders or a device different from the n sensing responders.

As shown in FIG. 4, the method 300 includes the following processes.

In S301, an SBP requester transmits a first request frame to an SBP responder, wherein the first request frame is configured to instruct the SBP responder to establish at least one measurement setup.

In S302, the SBP responder transmits a response frame to the first request frame to the SBP requester, wherein the response frame to the first request frame is configured to instruct the SBP responder to accept or reject the first request frame. In some embodiments, the response frame to the first request frame is also referred to as an SBP response.

In S303, the SBP responder transmits a sensing measurement setup establish request to a sensing responder 1, wherein the sensing measurement setup establish request is configured to request to establish at least one measurement setup with the sensing responder 1.

In S304, the SBP responder receives a sensing measurement setup establish response from the sensing responder 1, wherein the sensing measurement setup establish response indicates that the sensing responder 1 establishes or rejects establishing the at least one measurement setup. For example, the sensing measurement setup establish response indicates that the sensing responder 1 establishes and/or rejects establishing a measurement setup in the at least one measurement setup.

In S305, the SBP responder transmits the sensing measurement setup establish request to a sensing responder i, wherein the sensing measurement setup establish request is configured to request to establish at least one measurement setup with the sensing responder i.

In S306, the SBP responder receives the sensing measurement setup establish response from the sensing responder i, wherein the sensing measurement setup establish response indicates that the sensing responder i establishes or rejects establishing the at least one measurement setup. For example, the sensing measurement setup establish response indicates that the sensing responder i establishes and/or rejects establishing a measurement setup in the at least one measurement setup.

In S307, the SBP responder transmits the sensing measurement setup establish request to a sensing responder n, wherein the sensing measurement setup establish request is configured to request to establish at least one measurement setup with the sensing responder n.

In S308, the SBP responder receives the sensing measurement setup establish response from the sensing responder n, wherein the sensing measurement setup establish response indicates that the sensing responder n establishes or rejects establishing the at least one measurement setup. For example, the sensing measurement setup establish response indicates that the sensing responder n establishes and/or rejects establishing a measurement setup in the at least one measurement setup.

In S309, the SBP responder transmits a first SBP report information to the SBP requester, wherein the first SBP report information indicates a setup result of the at least one measurement setup. For example, the first SBP report information indicates a measurement setup established or failed to be successfully established by the sensing responder n in the at least one measurement setup.

In S310, in the case that the at least one measurement setup is established, the SBP responder measures using a sensing measurement procedure. For example, the SBP responder initiates at least one measurement instance based on an instruction of the SBP requester, and receives measurement result(s) reported by the sensing responder 1 to the sensing responder n based on the at least one measurement instance. The at least one measurement instance belongs to the same measurement setup or different measurement setups, for example, various measurement instances belong to one measurement setup or are shared by a plurality of measurement setups. Sensing measurement result(s) of each of the at least one measurement instance includes measurement result(s) reported by one or more of the n sensing responders.

In S311, the SBP responder transmits a second SBP report information to the SBP requester upon receiving the measurement result(s) of the at least one sensing responder in the at least one measurement instance, wherein the second SBP report information indicates the sensing measurement result(s) of the at least one sensing responder in the at least one measurement instance.

The structures of the first request frame and the response frame to the first request frame are illustrated. It should be understood that in other embodiments, the fields involved in the present disclosure can be equivalent to terms with similar meanings, such as fields or elements, and the fields involved in the present disclosure may include one or more bytes, or one or more bits.

In some embodiments, the first request frame includes a first Action Category field and a first Public Action Sub-category field, wherein the first Action Category field indicates that the first request frame is a public action frame, and the first Public Action Sub-category field indicates that the first request frame is an SBP request frame.

Illustratively, a value carried in the first Action Category field indicates that the first request frame is the public action frame, and a value carried in the first Public Action Sub-category field indicates that the first request frame is the SBP request frame.

In some embodiments, the first request frame includes a second Action Category field and a first Sensing Action Sub-category field, wherein the second Action Category field indicates that the first request frame is a sensing action frame, and the first Sensing Action Sub-category field indicates that the first request frame is an SBP request frame.

Illustratively, a value carried in the second Action Category field indicates that the first request frame is the sensing action frame, and a value carried in the first Sensing Action Sub-category field indicates that the first request frame is the SBP request frame.

It should be understood that the term “action” in the present disclosure is equivalent to a description with similar meaning such as motion, which is not limited in the present disclosure. For example, the first Action Category field is also referred to as the first motion category field, and the first Public Action Sub-category field is also referred to as the first Public Motion Sub-category field. For example, the second Action Category field is also referred to as the second Motion Category field, and the first Sensing Action Sub-category field is also referred to as the first Sensing Motion Sub-category field.

In some embodiments, the first request frame includes a Sensing Requirement Info field corresponding to a first measurement setup in the at least one measurement setup, wherein the Sensing Requirement Info field is configured for the SBP responder to establish the first measurement setup.

Illustratively, different measurement setups in the at least one measurement setup correspond to different Sensing Requirement Info fields or correspond to the same Sensing Requirement Info field. For example, the first request frame includes Sensing Requirement Info fields corresponding to all measurement setups in the at least one measurement setup. For example, the first request frame includes a Sensing Requirement Info field shared by the at least one measurement setup.

In some embodiments, the Sensing Requirement Info field includes at least one of:
a Control field, indicating whether the Sensing Requirement Info field includes a field indicating a measurement requirement corresponding to the first measurement setup;
a Trigger Frame-based field, indicating whether a measurement procedure of the first measurement setup is triggered by a trigger frame; or
a Measurement Result Type field, indicating a type of a first measurement result acquired based on the first measurement setup.

Illustratively, in the case that the measurement requirement corresponding to the first measurement setup includes a plurality of measurement requirements, the Control field is configured to carry a plurality of values. The plurality of values respectively indicate whether the Sensing Requirement Info field includes the plurality of measurement requirements. In some embodiments, the Control field is configured to carry one value, and the value indicates whether the Sensing Requirement Info field includes the plurality of measurement requirements.

Illustratively, a value carried in the Trigger Frame-based field indicates whether the measurement procedure of the first measurement setup is triggered by the trigger frame.

Illustratively, a value carried in the Measurement Result Type field indicates the type of the first measurement result acquired based on the first measurement setup.

Illustratively, the measurement requirement corresponding to the first measurement setup is a requirement of the sensing measurement based on the first measurement setup, or a requirement of the measurement result acquired based on the first measurement setup. In some embodiments, the measurement requirement corresponding to the first measurement setup is equivalent to a required condition for the sensing measurement based on the first measurement setup and/or a required condition for the measurement result acquired based on the first measurement setup.

In some embodiments, the Sensing Requirement Info field includes at least one of:
a Use Case Type field, indicating a required use case type for a sensing measurement based on the first measurement setup;
a Range Accuracy field, indicating a required range accuracy for the first measurement result;
a Velocity Accuracy field, indicating a required velocity accuracy for the first measurement result;
an Angular Accuracy field, indicating a required angular accuracy for the first measurement result;
a Measurement Frequency field, indicating a required measurement frequency for the sensing measurement based on the first measurement setup;
a Sensing Duration field, indicating a required duration for the sensing measurement based on the first measurement setup;
a Number of Sensing Responders field, indicating a number of sensing responders in the sensing measurement based on the first measurement setup; or
a Sensing Responder List field, indicating information of the sensing responders in the sensing measurement based on the first measurement setup.

Illustratively, a value carried in the Use Case Type field indicates the required use case type for the sensing measurement based on the first measurement setup, a value carried in the Range Accuracy field indicates the required range accuracy for the first measurement result, a value carried in the Velocity Accuracy field indicates the required velocity accuracy for the first measurement result, a value carried in the Angular Accuracy field indicates a required angular accuracy for the first measurement result, a value carried in the Measurement Frequency field indicates the required measurement frequency for the sensing measurement based on the first measurement setup, a value carried in the Sensing Duration field indicates the required duration for the sensing measurement based on the first measurement setup, a value carried in the Number of Sensing Responders field indicates the number of sensing responders in the sensing measurement based on the first measurement setup, and a value carried in the Sensing Responder List field indicates information of the sensing responders in the sensing measurement based on the first measurement setup.

Illustratively, the Control field includes at least one of:
a Use Case Type Present field, indicating whether the Sensing Requirement Info field includes the use case type field;
a Range Accuracy Present field, indicating whether the Sensing Requirement Info field includes the range accuracy field;
a Velocity Accuracy Present field, indicating whether the Sensing Requirement Info field includes the velocity accuracy field;
an Angular Accuracy Present field, indicating whether the Sensing Requirement Info field includes the Angular Accuracy field;
a Measurement Frequency Present field, indicating whether the Sensing Requirement Info field includes the Measurement Frequency field;
a Sensing Duration Present field, indicating whether the Sensing Requirement Info field includes the sensing duration field;
a Number of Sensing Responder Present field, indicating whether the Sensing Requirement Info field includes the Number of Sensing Responder field; or
a Sensing Responder List Present field, indicating whether the Sensing Requirement Info field includes the sensing responder list field.

Illustratively, a value carried in the Use Case Type Present field indicates whether the Sensing Requirement Info field includes the Use Case Type field, a value carried in the Range Accuracy Present field indicates whether the Sensing Requirement Info field includes the Range Accuracy field, a value carried in the Velocity Accuracy Present field indicates whether the Sensing Requirement Info field includes the Velocity Accuracy field, a value carried in the Angular Accuracy Present field indicates whether the Sensing Requirement Info field includes the Angular Accuracy field, a value carried in the Measurement Frequency Present field indicates whether the Sensing Requirement Info field includes the Measurement Frequency field, a value carried in the Sensing Duration Present field indicates whether the Sensing Requirement Info field includes the Sensing Duration field, a value carried in the Number of Sensing Responders Present field indicates whether the Sensing Requirement Info field includes the Number of Sensing Responders field, and a value carried in the Sensing Responder List Present field indicates whether the Sensing Requirement Info field includes the Sensing Responder List field.

In some embodiments, the type of the first measurement result includes at least one of:
CSI, a beam signal-to-noise ratio (SNR), a truncated channel impulse response (TCIR), a truncated power delay profile (TPDP), only amplitude information in CSI (CSI amplitude only), only phase information in CSI (CSI phase only), an angle of arrival (AoA) of a signal, or an angle of departure (AoD) of the signal.

Illustratively, the CSI indicates a channel frequency response (CFR), and the CSI and the CFR are Fourier transforms of each other.

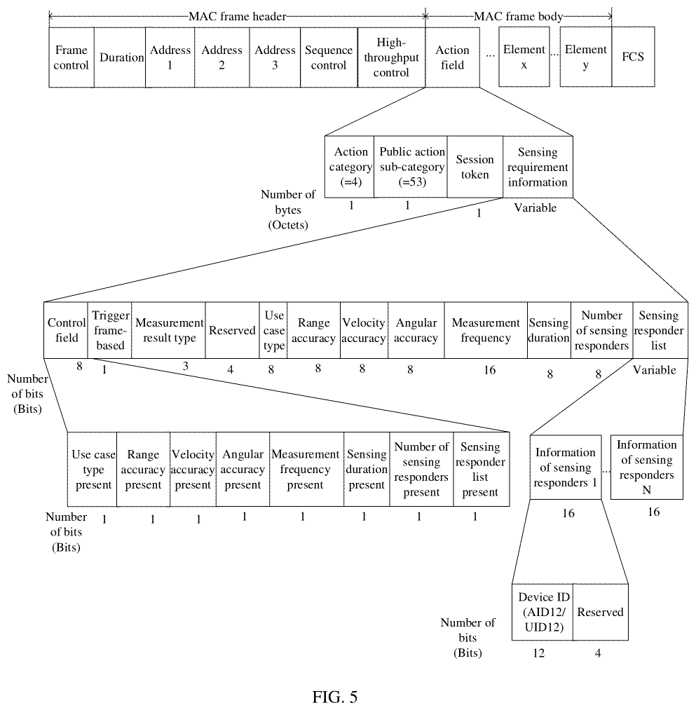

FIG. 5 is an example of a first request frame according to some embodiments of the present disclosure.

As shown in FIG. 5, the first request frame is determined as a new action frame or an action no ack frame. The first request frame includes a MAC frame header and a MAC frame body, and both the MAC frame header and the MAC frame body include a plurality of fields. The plurality of fields in the MAC frame body include action fields, and the action fields include one or more fields.

Illustratively, the action field includes an Action Category field, a Public Action Sub-category field, a Session Token field, and a Sensing Requirement Info field.

The Action Category field indicates that the first request frame is a public action frame. For example, the first request frame is the public action frame in the case that a value carried in the Action Category field of the first request frame is 4.

The Public Action Sub-category field indicates that the first request frame is an SBP request frame. For example, the first request frame is the SBP request frame in the case that a value carried in the Public Action Sub-category field is 53 (any value in the range of 51 to 255).

The Session Token field is configured for the SBP requester to determine an application corresponding to the measurement result.

The Sensing Requirement Info field is configured for the SBP responder to establish the first measurement setup.

Illustratively, the Sensing Requirement Info field includes all or part of a Control field, a Use Case Type Present field, a Range Accuracy Present field, a Velocity Accuracy Present field, an Angular Accuracy Present field, a Measurement Frequency Present field, a Sensing Duration Present field, a Number of Sensing Responders Present field, a Sensing Responder List Present field, a Trigger (TB) Frame-based field, and a Measurement Result Type field.

The Control field (also referred to as a control field) indicates whether one or more subsequent fields are present.

The Use Case Type Present field indicates whether the subsequent use case type field is present. In some embodiments, 1 is set to represent Yes, and otherwise 0 is set to represent No. In some embodiments, 0 is set to represent Yes, and otherwise 1 is set to represent No.

The Range Accuracy Present field indicates whether the subsequent range accuracy field is present. In some embodiments, 1 is set to represent Yes, and otherwise 0 is set to represent No. In some embodiments, 0 is set to represent Yes, and otherwise 1 is set to represent No. In the case that the range accuracy field is not present, no range accuracy requirement, a default range accuracy, or a predefined range accuracy is for the measurement requirement to be established by the proxy as in the request.

The Velocity Accuracy Present field indicates whether the subsequent velocity accuracy field is present. In some embodiments, 1 is set to represent Yes, and otherwise 0 is set to represent No. In some embodiments, 0 is set to represent Yes, and otherwise 1 is set to represent No. In the case that the velocity accuracy field is not present, no velocity accuracy requirement, a default velocity accuracy, or a predefined velocity accuracy is for the measurement requirement to be established by the proxy as in the request.

The Angular Accuracy Present field indicates whether the subsequent angular accuracy field is present. In some embodiments, 1 is set to represent Yes, and otherwise 0 is set to represent No. In some embodiments, 0 is set to represent Yes, and otherwise 1 is set to represent No. In the case that the angular accuracy field is not present, no angular accuracy requirement, a default angular accuracy, or a predefined angular accuracy is for the measurement requirement to be established by the proxy as in the request.

The Measurement Frequency Present field indicates whether the subsequent Measurement Frequency field is present. In some embodiments, 1 is set to represent Yes, and otherwise 0 is set to represent No. In some embodiments, 0 is set to represent Yes, and otherwise 1 is set to represent No. In the case that the measurement frequency field is not present, no measurement frequency requirement, a default measurement frequency, or a predefined measurement frequency is for the measurement requirement to be established by the proxy as in the request.

The Sensing Duration Present field indicates whether the subsequent Sensing Duration field is present. In some embodiments, 1 is set to represent Yes, and otherwise 0 is set. In some embodiments, 0 is set to represent Yes, and otherwise 1 is set. In the case that the Sensing Duration field is not present, no sensing duration requirement, a default sensing duration, or a predefined sensing duration is for the measurement requirement to be established by the proxy as in the request.

The Number of Sensing Responder Present field indicates whether the subsequent Number of Sensing Responders field is present. In some embodiments, 1 is set to represent Yes, and otherwise 0 is set to represent No. In some embodiments, 0 is set to represent Yes, and otherwise 1 is set to represent No. In the case that the Number of Sensing Responders field is not present, regarding the number of sensing responders, no requirement is imposed for the measurement requirement setup to be established by the proxy as in the request, or a default number or a predefined number is indicated for the measurement setup.

The Sensing Responder List Present field indicates whether the subsequent Sensing Responder List field is present. In some embodiments, 1 is set to represent Yes, and otherwise 0 is set to represent No. In some embodiments, 0 is set to represent Yes, and otherwise 1 is set to represent No.

The Trigger (TB) Frame-based field indicates whether a sensing measurement procedure corresponding to the measurement setup to be established by the proxy as in the request is triggered by the trigger frame. “Yes” represents that the sensing measurement procedure is triggered by the trigger frame, and “No” represents that the sensing measurement procedure is not triggered by the trigger frame. In some embodiments, 1 is set to represent Yes, and otherwise 0 is set to represent No. In some embodiments, 0 is set to represent Yes, and otherwise 1 is set to represent No.

The Measurement Result Type field indicates a measurement result type in the measurement setup to be established by the proxy as in the request. 0 represents the CSI, 1 represents the beam SNR, 2 represents the TCIR, the CSI and the CFR are Fourier transforms of each other, 3 represents the TPDP, 4 represents the CSI amplitude only information, 5 represents the CSI phase only information, 6 represents the AoA of the signal, 7 represents the AoD of the signal, and 8 to 15 are reserved. Values in the fields are exemplary or are set to other values as long as a value corresponding to each measurement type is different from values of other measurement types. For example, 2 represents the CSI, and 1 represents the beam SNR. For example, 8 represents the CSI, and 15 represents the beam SNR, and the like.

The Use Case Type field indicates a sensing use type. 0 represents person presence detection, 1 represents person number detection, 2 represents person position detection, 3 represents posture detection, 4 represents vital signs detection, 5 represents sleep detection, while 6 to 255 are reserved. Values in the fields are exemplary or are set to other values as long as a value corresponding to each type is different from values of other types.

The Range Accuracy field indicates a required range accuracy for the measurement result generated based on the sensing measurement corresponding to the measurement setup to be established by the proxy as in the request. The range accuracy is an accuracy of range data by calculating the measurement result.

The Velocity Accuracy field indicates a required velocity accuracy for the measurement result generated based on the sensing measurement corresponding to the measurement setup to be established by the proxy as in the request. The velocity accuracy is an accuracy of velocity data by calculating the measurement result.

The Angular Accuracy field indicates a required angular accuracy for the measurement result generated based on the sensing measurement corresponding to the measurement setup to be established by the proxy as in the request. The angular accuracy is an accuracy of angular data by calculating the measurement result.

The Measurement Frequency field indicates a required measurement frequency for the sensing measurement corresponding to the measurement setup to be established by the proxy as in the request. For example, 10 represents 10 Hz (that is, 10 times per second), and indicates that one measurement instance is initiated per 100 ms based on the measurement setup. 0 is a reserved value, or 0 represents no implicit requirement for the measurement frequency.

The Sensing Duration field indicates a required duration for the sensing measurement corresponding to the measurement setup to be established by the proxy as in the request. 0 is a reserved value, or 0 represents permanent. Illustratively, the unit is 1 minute, 1 represents one minute, 2 represents two minutes, and so on. Illustratively, the unit is 1 minute, 1 represents one minute, 2 represents two minutes, 3 represents four minutes, 4 represents eight minutes, 5 represents 16 minutes, and so on.

The Number of Sensing Responders field indicates a requirement for a number of sensing responders in the measurement setup to be established by the proxy as in the request. 0 is a reserved value, or 0 represents no clear requirement for the number of sensing responders.

The Sensing Responder List field indicates information of one or more sensing responders. In the case that the field is present, the number of sensing responders needs to be present, and the number of sensing responders is a number of pieces of information of the sensing responders in the sensing responder list.

Illustratively, the Sensing Responder List field includes Sensing Responder Info field corresponding to each sensing responder in the sensing responder list. The Sensing Responder Info field indicates information of a sensing responder. For example, in the case that the sensing responder list includes the sensing responder 1 to the sensing responder N, the Sensing Responder List field includes a field for carrying the sensing responder information 1 corresponding to the sensing responder 1 in the sensing responder list to a field for carrying the sensing responder information N corresponding to the sensing responder N in the sensing responder list.

Illustratively, the Sensing Responder Info field includes:
a sensing responder identifier (associated identifier (AID)/unassociated identifier (UID)), indicating an identifier (ID) of the sensing responder. An AID (UID is assigned by the AP, and an assigned space is the same with the AID) is for an associated STA, an UID is for an unassociated STA, and 0 is the AID of the associated AP. In some embodiments, the field is changed to a MAC address of the sensing responder (correspondingly, a length is changed to 6 bytes).

It should be understood that FIG. 5 is an example of the present disclosure, and should not be constructed as a limitation of the present disclosure.

For example, in some embodiments, the value carried in each field is set to other values, and the length of each field is also set to other values, which are not limited in the present disclosure.

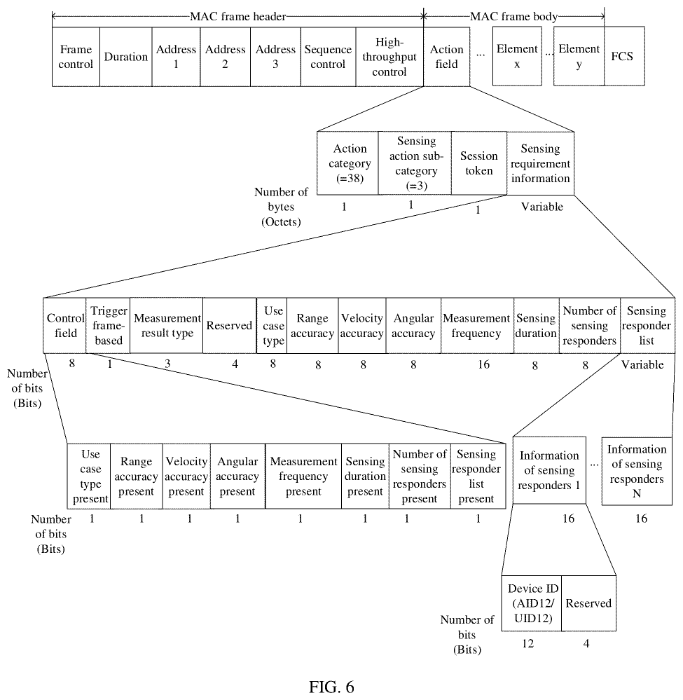

FIG. 6 is another example of a first request frame according to some embodiments of the present disclosure.

As shown in FIG. 6, the first request frame is determined as a new action frame or an action no ack frame. The first request frame includes a MAC frame header and a MAC frame body, and both the MAC frame header and the MAC frame body include a plurality of fields. The plurality of fields in the MAC frame body include action fields, and the action fields include one or more fields.

Illustratively, the action fields include an Action Category field and a Sensing Action Sub-category field.

The Action Category field indicates that the first request frame is a sensing action frame.

The first request frame is the sensing action frame in the case that a value carried in the Action Category field is 38.

The Sensing Action Sub-category field indicates that the first request frame is an SBP request frame. For example, the first request frame is a protected SBP request frame in the case that a value carried in the Sensing Action Sub-category field is 3 (any value in the range of 0 to 255).

It should be understood that the field subsequent to the Sensing Action Sub-category field is the same as the field subsequent to the Public Action Sub-category field shown in FIG. 5, which are not repeated herein.

In some embodiments, the Sensing Requirement Info field includes a Measurement Participant field indicating whether the SBP requester participates in the at least one measurement setup.

Illustratively, a value carried in the Measurement Participant field indicates whether the SBP requester participates in the at least one measurement setup.

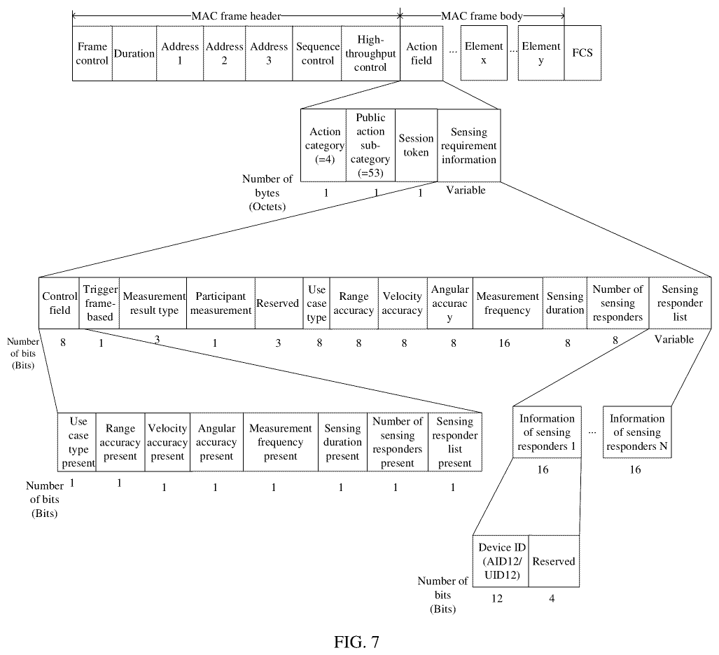

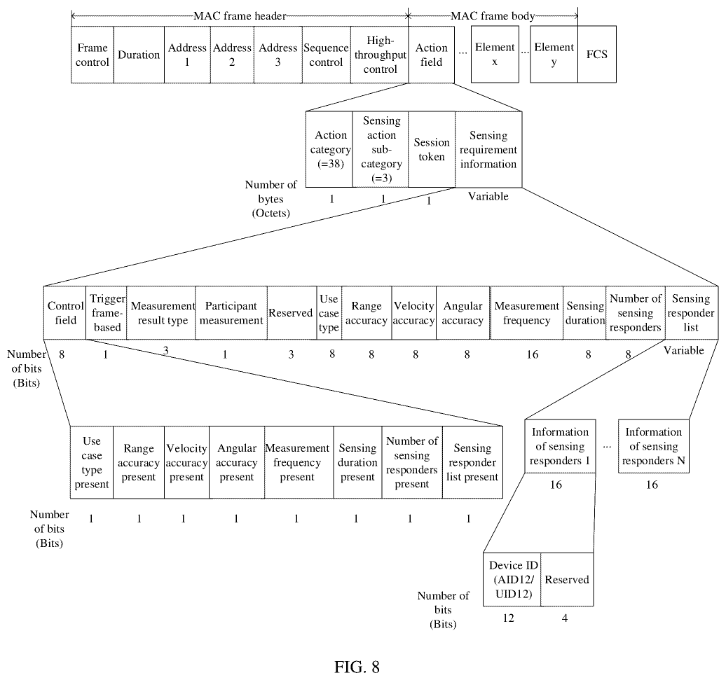

FIGS. 7 and 8 are examples of a Sensing Requirement Info field including a Measurement Participant field according to some embodiments of the present disclosure.

As shown in FIG. 7, on the basis of the structure of the first request frame shown in FIG. 5, one of four reserved bits is determined as the Measurement Participant field. As shown in FIG. 8, on the basis of the structure of the first request frame shown in FIG. 6, one of four reserved bits is determined as the Measurement Participant field. The Measurement Participant field indicates whether the SBP requester participates in the at least one measurement setup. In some embodiments, 1 is set to represent Yes, and otherwise 0 is set to represent No. in some embodiments, 0 is set to represent Yes, and otherwise 1 is set to represent No.

In some embodiments, the Sensing Requirement Info field includes an Immediate Report field indicating whether a sensing signal receiver immediately reports measurement results acquired based on the at least one measurement setup.

Illustratively, a value carried in the Immediate Report field indicates whether the sensing signal receiver immediately reports the measurement results acquired based on the at least one measurement setup.

Illustratively, in the case that the Immediate Report field indicates that the sensing signal receiver immediately reports the measurement result, the sensing signal receiver that is not capable of immediately reporting the measurement result does not participate in the at least one measurement setup to be established as requested by the SBP requester.

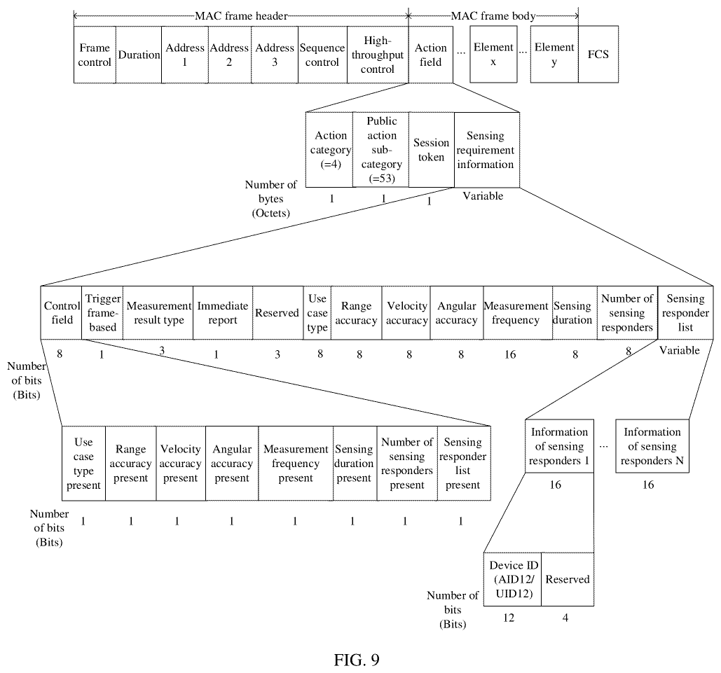

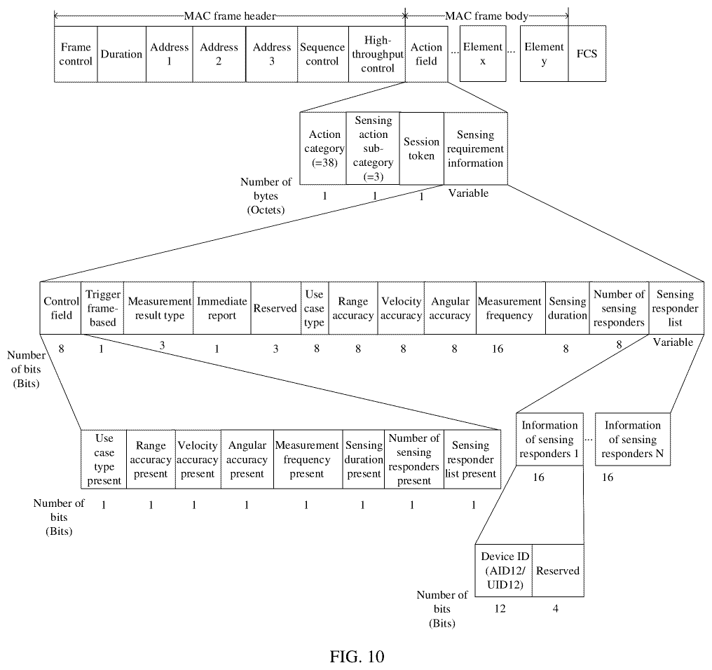

FIGS. 9 and 10 are examples of a Sensing Requirement Info field including a Measurement Participant field according to some embodiments of the present disclosure.

As shown in FIG. 9, on the basis of the structure of the first request frame shown in FIG. 5, one of four reserved bits is determined as the Immediate Report field. As shown in FIG. 10, on the basis of the structure of the first request frame shown in FIG. 6, one of four reserved bits is determined as the Immediate Report field. The Immediate Report field indicates whether the sensing signal receiver immediately reports the measurement results in the sensing measurement corresponding to the at least one measurement setup to be established as requested by the SBP requester. In some embodiments, 1 is set to represent Yes, and otherwise 0 is set to represent No. In some embodiments, 0 is set to represent Yes, and otherwise 1 is set to represent No. In the case that the sensing result is required to be reported immediately, the sensing signal receiver that is not capable of immediately reporting the sensing result does not participate in the sensing measurement setup to be established based on the SBP request.

In some embodiments, the Sensing Requirement Info field includes a Proxy Report Scheme field indicating a report scheme by which the SBP responder reports measurement result(s) acquired based on the at least one measurement setup to the SBP requester.

Illustratively, a value carried in the Proxy Report Scheme field indicates a report scheme by which the SBP responder reports measurement results acquired based on the at least one measurement setup to the SBP requester. The Proxy Report Scheme field is also referred to as a proxy report method field.

Illustratively, the report scheme includes, but is not limited to immediate forwarding, forwarding after each instance, instance specific forwarding.

In some embodiments, in the case that the Sensing Requirement Info field does not include the Proxy Report Scheme field, the SBP requester reports the measurement results acquired based on the at least one measurement setup in a predetermined report scheme.

Illustratively, the report scheme includes, but is not limited to immediate forwarding, forwarding after each instance, instance specific forwarding.

It should be understood that in the embodiments of the present disclosure, the term “predetermination” is achieved by pre-storing corresponding codes or forms in the device (for example, including the STA and the network device) or other means for indicating relevant information, and the specific implementations are not limited in the present disclosure. For example, the predefinition is defined in the protocol. Illustratively, the “protocol” indicates standard protocols in the field of communications, for example, the Wi-Fi protocol and related protocols applied to the future Wi-Fi communication system, which are not limited in the present disclosure.

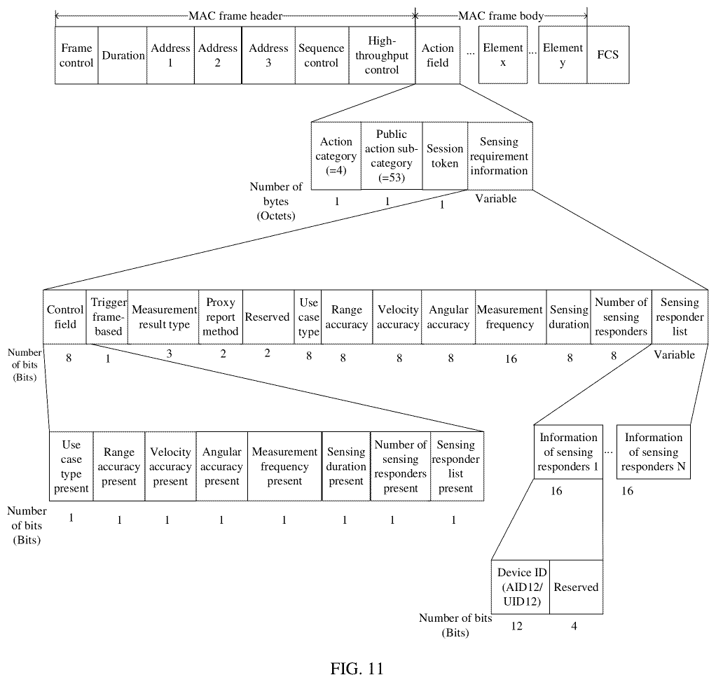

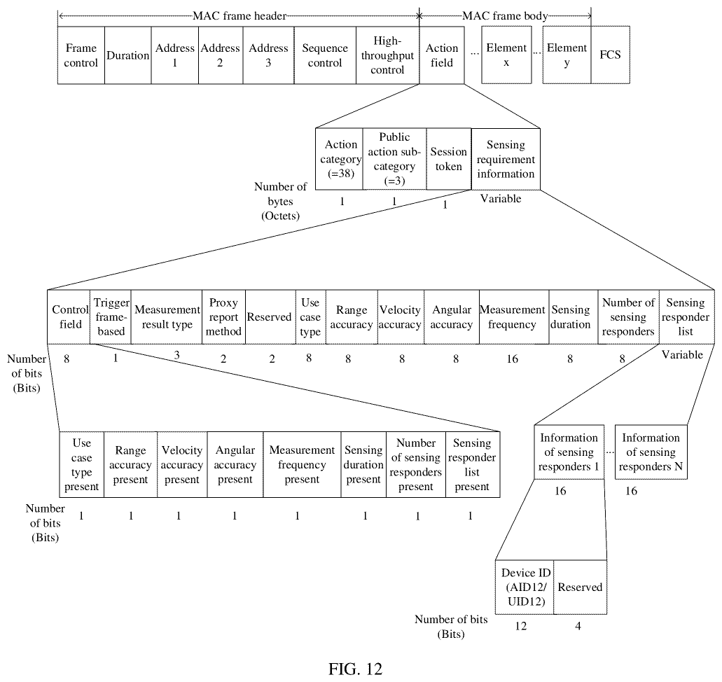

FIGS. 11 and 12 are examples of a Sensing Requirement Info field including a Proxy Report Scheme field according to some embodiments of the present disclosure.

As shown in FIG. 11, on the basis of the structure of the first request frame shown in FIG. 5, two of four reserved bits are determined as the Proxy Report Scheme fields. As shown in FIG. 12, on the basis of the structure of the first request frame shown in FIG. 6, two of four reserved bits is determined as the Proxy Report Scheme fields. The Proxy Report Scheme field indicates how the SBP responder reports the measurement results to the SBP requester in the sensing measurement corresponding to the measurement setup to be established by the proxy as in the request. Illustratively, 0 represents the immediate forwarding, 1 represents the forwarding after each instance, 2 represents the instance specific forwarding, and 4 is a reserved value. Values in the fields are exemplary or are set to other values as long as a value corresponding to each method is different from values of other methods.

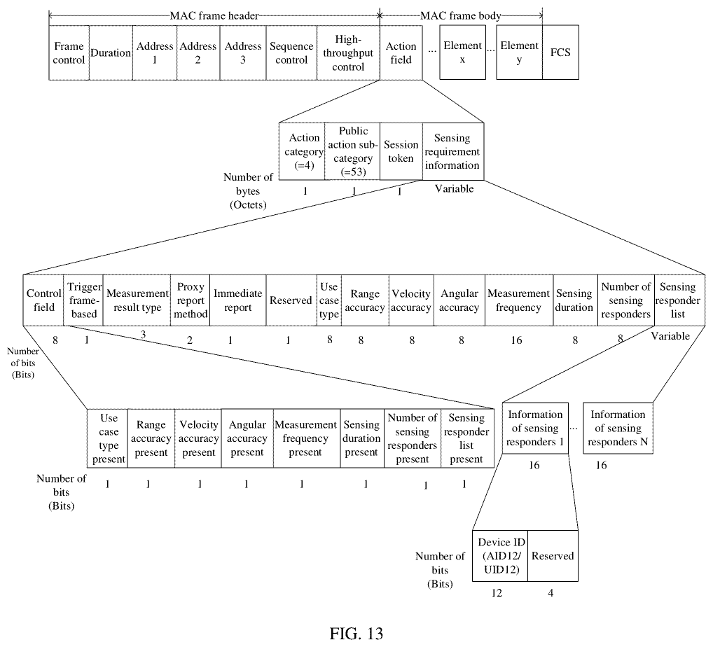

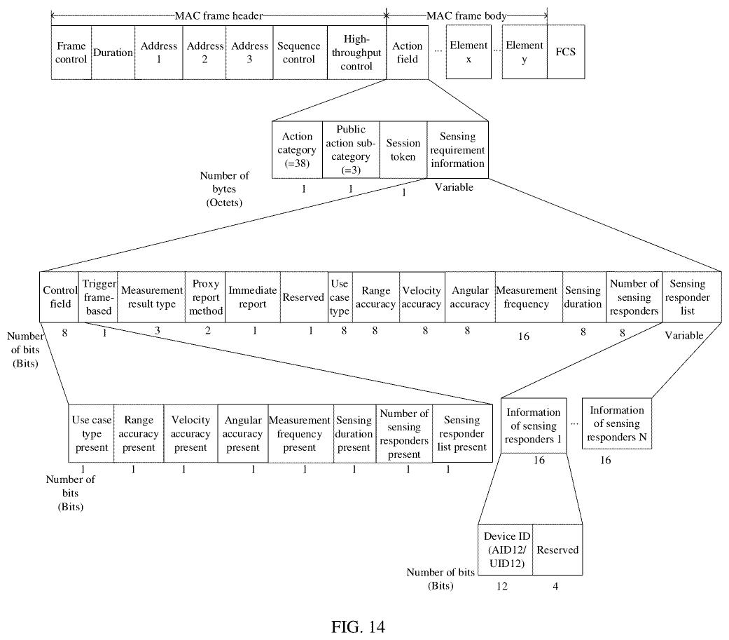

FIGS. 13 and 14 are examples of a Sensing Requirement Info field including a measurement field and a Proxy Report Scheme field according to some embodiments of the present disclosure.

As shown in FIG. 13, on the basis of the structure of the first request frame shown in FIG. 5, one of four reserved bits is determined as the Immediate Report field, and two of four reserved bits are determined as the Proxy Report Scheme field. As shown in FIG. 14, on the basis of the structure of the first request frame shown in FIG. 6, one of four reserved bits is determined as the Measurement Participant field, and two of four reserved bits are determined as the Proxy Report Scheme fields.

In some embodiments, the at least one measurement setup includes a plurality of measurement setups, and the Sensing Requirement Info field includes an Element ID field indicating an identifier of the Sensing Requirement Info field.

Illustratively, a value carried in the Element ID field indicates an identifier of the Sensing Requirement Info field.

Furthermore, the Sensing Requirement Info field further includes a Length field indicating a length of the Sensing Requirement Info field of the first measurement setup.

In some embodiments, in the case that the at least one measurement setup includes a plurality of measurement setups, the first request frame includes a plurality of Sensing Requirement Info fields corresponding to the plurality of measurement setups. For example, the plurality of measurement setups are in one-to-one correspondence with the plurality of Sensing Requirement Info fields.

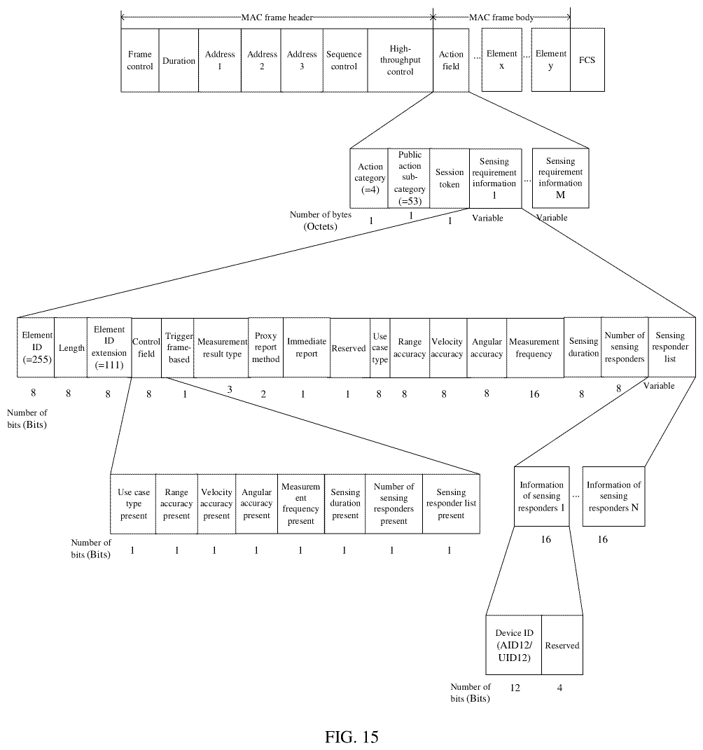

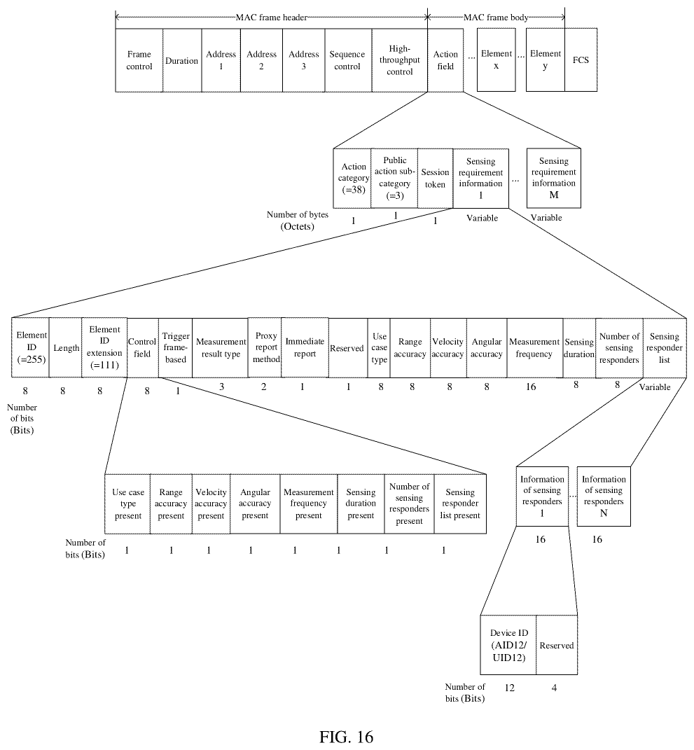

FIGS. 15 and 16 are examples of first request frames requesting to establish a plurality of measurement setups according to some embodiments of the present disclosure.

As shown in FIG. 15, on the basis of the structure of the first request frame shown in FIG. 13, the first request frame includes M Sensing Requirement Info fields, and the M Sensing Requirement Info fields are respectively configured for the SBP responder to establish M measurement setups. As shown in FIG. 16, on the basis of the structure of the first request frame shown in FIG. 14, the first request frame includes M Sensing Requirement Info fields, and the M Sensing Requirement Info fields are respectively configured for the SBP responder to establish M measurement setups.

Illustratively, each of the M Sensing Requirement Info fields further includes Element ID fields indicating identifiers of the Sensing Requirement Info field. For example, an extension value of the Element ID field is 111 (any value in the range of 111 to 255). Furthermore, the Sensing Requirement Info field further includes a Length field indicating a length of the Sensing Requirement Info field of the first measurement setup.

In some embodiments, the Sensing Requirement Info field is extended to a plurality of Sensing Requirement Info fields in any accompanying drawing in FIG. 5 to FIG. 14, which is not limited in the present disclosure.

In some embodiments, the Sensing Requirement Info field includes a Scheduling Info field configured to schedule a plurality of proxy devices to establish the first measurement setup, wherein the plurality of proxy devices include the SBP responder.

Illustratively, a value carried in the Scheduling Info field is configured to schedule the plurality of proxy devices to establish the first measurement setup.

In some embodiments, the Scheduling Info field is configured to determine a start time of a first measurement instance based on the first measurement setup.

Illustratively, a value carried in the Scheduling Info field is configured to determine a start time of a first measurement instance based on the first measurement setup.

In some embodiments, the plurality of proxy devices include a first proxy device associated with the SBP requester, and the Scheduling Info field indicates an offset of a start time at which the first proxy device initiates the first measurement instance relative to a time at which the first proxy device receives the first request frame.

Illustratively, in the case that the SBP responder is the first proxy device, the SBP responder determines, based on an offset indicated by the Scheduling Info field and a time for receiving the first request frame, a start time at which the SBP responder initiates the first measurement instance. In the case that the SBP responder is not the first proxy device, the SBP responder determines, based on an offset indicated by the Scheduling Info field, an offset of a local time of the SBP responder and a local time of the first proxy device, and a time for receiving the first request frame, a start time at which the SBP responder initiates the first measurement instance.

Illustratively, a time at which the first proxy device receives the first request frame is a start time or an end time at which the first proxy device receives the first request frame.

Illustratively, a time at which the first proxy device receives the first request frame is any time in the process of receiving the first request frame by the first proxy device.

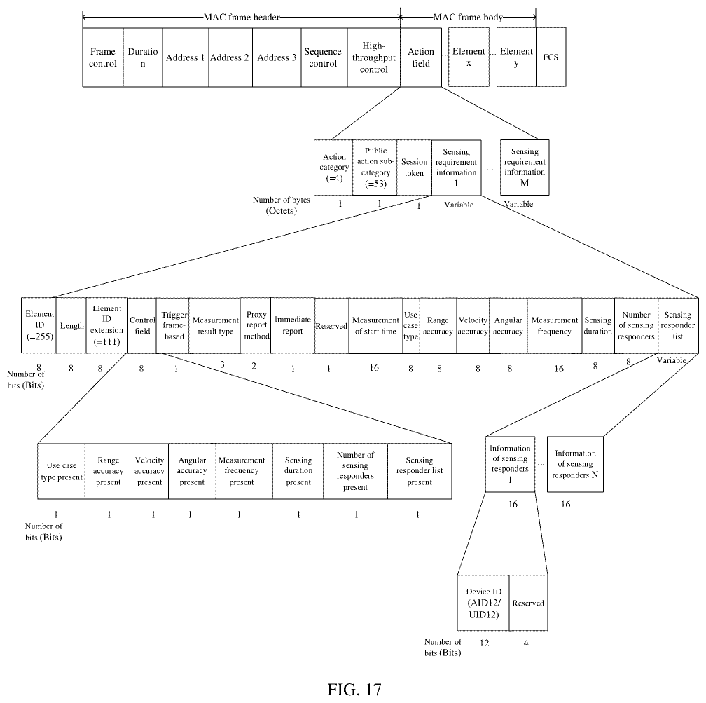

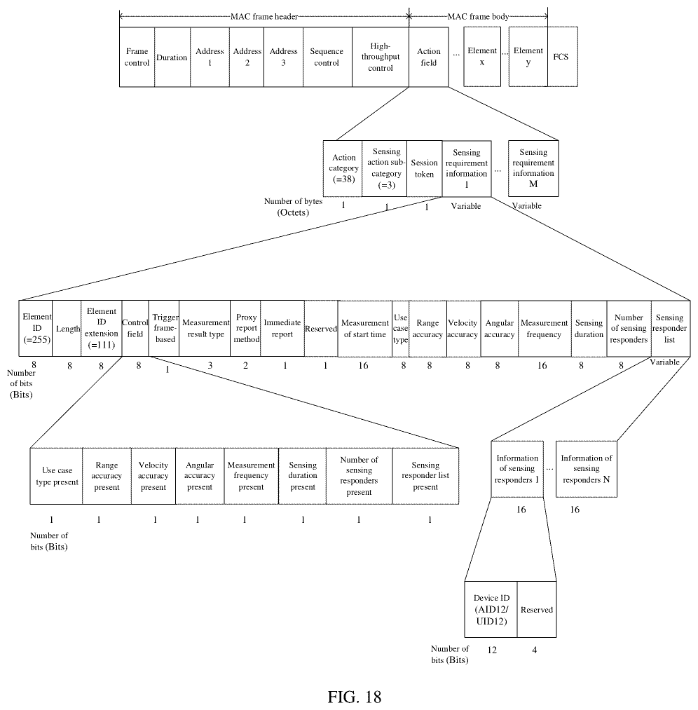

FIGS. 17 and 18 are examples of a Sensing Requirement Info field including a Scheduling Info field according to some embodiments of the present disclosure.

As shown in FIG. 17, on the basis of the structure of the first request frame shown in FIG. 15, 16 bits of Scheduling Info fields are added in each Sensing Requirement Info field for requesting a plurality of proxy devices to establish corresponding measurement setups in coordination with each other. As shown in FIG. 18, on the basis of the structure of the first request frame shown in FIG. 16, 16 bits of Scheduling Info fields are added in each Sensing Requirement Info field for requesting a plurality of proxy devices to establish corresponding measurement setups in coordination with each other.

A Measurement Start Time field indicates a start time of the first measurement instance in the corresponding measurement setup, and is set as a partial timing synchronization function (TSF) value of a target time or an offset of the target time relative to a current time. The TSF represents the timing synchronization function, and partial TSF represents truncated data of a synchronization time value. For example, the most significant 38 bits and the least significant 10 bits are removed from the 64 TSF timer bits. As times of different SBP responders are not synchronized, field values are different for different proxy responders and are the same relative to the local time of the SBP requester, such that various measurement instances are synchronously achieved on different proxy responders based on the corresponding measurement setups. For example, in the case that the local time of the SBP requester STA1 device is 1000, the time of the associated access point AP1 device (one of the SBP requesters) is also 1000 (the STA is generally synchronized with the associated AP), and another access point AP1 device (one of the SBP requesters) is 1005, the SBP request frame from the STA1 to the AP1 requests the measurement setup 1 to start the first measurement instance in the time of 1003 (adding 3 relative to 1000) and requests the measurement setup 2 to start the first measurement instance in the time of 1011 (adding 11 relative to 1000), and the SBP request frame from the STA1 to the AP2 requests the measurement setup 1 to start the first measurement instance in the time of 1008 (adding 3 relative to 1005) and requests the measurement setup 2 to start the first measurement instance in the time of 1016 (adding 11 relative to 1005).

In some embodiments, 16 bits or other lengths of Scheduling Info fields are added in any accompanying drawing in FIG. 5 to FIG. 14, which is not limited in the present disclosure.

In some embodiments, the method 200 further includes:
transmitting update information to the plurality of proxy devices, wherein the update information is configured to update the start time of the first measurement instance.

Illustratively, various proxy devices have different time offsets relative to the SBP requester, the SBP requester requires update of scheduling information established for the at least one measurement setup for various proxy devices after the sensing procedure running for a period. That is, a start time of a next measurement instance (that is, a first measurement instance from the current time) in the corresponding measurement setup is set.

In some embodiments, the response frame to the first request frame includes a third Action Category field and a second Public Action Sub-category field, wherein the third Action Category field indicates that the response frame to the first request frame is a public action frame, and the second Public Action Sub-category field indicates that the response frame to the first request frame is an SBP response frame.

Illustratively, a value carried in the third Action Category field indicates that the response frame to the first request frame is a public action frame, and a value carried in the second Public Action Sub-category field indicates that the response frame to the first request frame is an SBP response frame.

In some embodiments, the response frame to the first request frame includes a fourth Action Category field and a second Sensing Action Sub-category field, wherein the fourth Action Category field indicates that the response frame to the first request frame is a sensing action frame, and the second Sensing Action Sub-category field indicates that the response frame to the first request frame is an SBP response frame.

Illustratively, a value carried in the fourth Action Category field indicates that the response frame to the first request frame is a sensing action frame, and a value carried in the second Sensing Action Sub-category field indicates that the response frame to the first request frame is an SBP response frame.

In some embodiments, the response frame to the first request frame includes a Response Info field corresponding to a second measurement setup in the at least one measurement setup, wherein the Response Info field indicates that the SBP responder rejects establishing the second measurement setup, or the Response Info field is configured for the SBP requester to determine an application corresponding to a second measurement result acquired based on the second measurement setup.

Illustratively, a value carried in the Response Info field indicates that the SBP responder rejects establishing the second measurement setup, or a value carried in the Response Info field is configured for the SBP requester to determine an application corresponding to a second measurement result acquired based on the second measurement setup.

In some embodiments, the response frame to the first request frame includes a Status Code field indicating that the SBP responder establishes or rejects establishing the second measurement setup.

Illustratively, a value carried in the Status Code field indicates that the SBP responder establishes or rejects establishing the second measurement setup.

In some embodiments, in the case that the Status Code field indicates that the SBP responder rejects establishing the second measurement setup, the Status Code field further indicates a reason for rejecting establishing the second measurement setup.

Illustratively, a value carried in the Status Code field further indicates a reason for rejecting establishing the second measurement setup.

In some embodiments, in the case that the Status Code field indicates that the SBP responder accepts a request for establishing the second measurement setup, the Response Info field further includes a Measurement Setup ID field indicating an identifier of the second measurement setup; and the method 200 further includes:
reporting the second measurement result to an application corresponding to the identifier of the second measurement setup in the SBP requester.

Illustratively, the identifier of the second measurement setup is configured for the SBP requester to determine the application corresponding to the identifier of the second measurement setup.

In some embodiments, in the case that the Status Code field indicates that the SBP responder accepts a request for establishing the second measurement setup, the response frame to the first request frame further includes a session token corresponding to an identifier of the second measurement setup; and the method 200 further includes:
reporting the second measurement result to an application corresponding to the session token in the SBP requester.

Illustratively, the session token is configured for the SBP requester to determine the application corresponding to the session token.

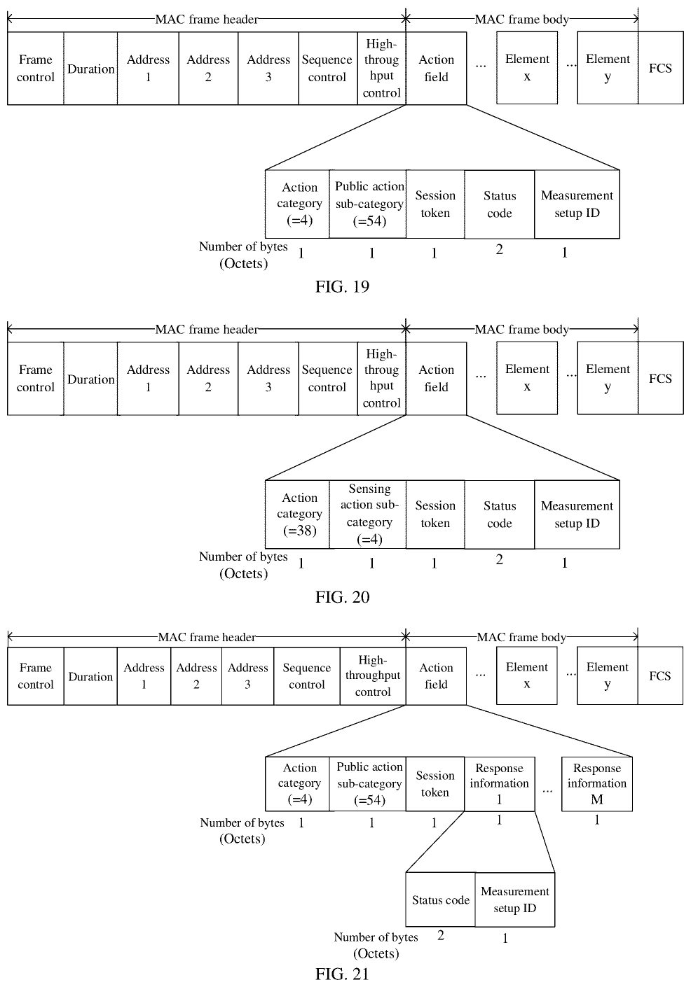

FIG. 19 is an example of a response frame to a first request frame according to some embodiments of the present disclosure.

As shown in FIG. 19, the response frame to the first request frame is determined as a new action frame or an action no ack frame. The response frame to the first request frame includes a MAC frame header and a MAC frame body, and both the MAC frame header and the MAC frame body include a plurality of fields. The plurality of fields in the MAC frame body include action fields, and the action fields include one or more fields.

Illustratively, the action field includes an Action Category field, a Public Action Sub-category field, a Session Token field, a State Code field, and a measurement setup ID field.

The Action Category field indicates that the response frame to the first request frame is a public action frame. For example, the response frame to the first request frame is the public action frame in the case that a value carried in the Action Category field of the response frame to the first request frame is 4.

The Public Action Sub-category field indicates that the response frame to the first request frame is an SBP response frame. For example, the response frame to the first request frame is the SBP response frame in the case that a value carried in the Public Action Sub-category field is 54 (any value in the range of 51 to 255).

The Session Token field is configured for the SBP requester to determine an application corresponding to the measurement result.

In the Status Code field, 0 represents success (that is, accepting the request), 1 represents failure (that is, rejecting the request without reason), and 113 (any value in the range of 113 to 65535) represents rejecting the request due to an insufficient number of sensing participants. Values in the fields are exemplary or are set to other values as long as a value corresponding to each status code is different from values of other status codes.

The measurement setup ID field indicates an identifier of a to-be-set-up measurement setup. In the case that the status code successfully indicates, the field is present, and otherwise the field is not present.

In some embodiments, the SBP requester identifies the sensing measurement result by a 3-tuple composed of the sensing proxy request session token (the same as the SBP response session token), the identifier of the SBP responder, and the measurement setup ID. The SBP responder saves the identifier of the SBP requester, the sensing proxy request session token, and one or more measurement setup identifiers corresponding to the sensing proxy request. The SBP responder identifies a measurement result reported by the sensing signal receiver by the measurement setup identifiers to correspond to the 3-tuple composed of the identifier of the corresponding SBP requester, the sensing proxy request session token, and the measurement setup ID, and indicates the identifier of the SBP responder, the identifier of the SBP requester, the sensing proxy request session token, and the measurement setup ID in reporting the measurement result to the SBP requester. The SBP requester further saves a corresponding relationship of information provided in calling a station management entity (SME) by an upper-layer application run therein and one or more sensing proxy request session tokens, such that the measurement result is accurately reported to the upper-layer application.

In some embodiments, the SBP requester identifies the sensing measurement result by a 2-tuple composed of the identifier of the SBP responder and the measurement setup ID. The SBP responder saves the identifier of the SBP requester and one or more measurement setup identifiers belonging to the SBP requester. The SBP responder identifies a measurement result reported by the sensing signal receiver by the measurement setup identifiers to correspond to the 2-tuple composed of the identifier of the corresponding SBP requester and the measurement setup ID, and indicates the identifier of the SBP responder, the identifier of the SBP requester, and the measurement setup ID in reporting the measurement result to the SBP requester. The measurement setup ID is carried in the Session Token field. The SBP requester further saves a corresponding relationship of information provided in calling a SME by an upper-layer application run therein and one or more measurement setup IDs, such that the measurement result is accurately reported to the upper-layer application.

In some embodiments, in the case that the status code successfully indicates, the SBP responder does not indicate the measurement setup ID (that is, the SBP response frame does not include the measurement setup ID). The SBP requester identifies the sensing measurement result by a 2-tuple composed of the identifier of the SBP requester and the sensing proxy request session token (the same as the SBP response session token). The SBP responder saves the identifier of the SBP requester, the sensing proxy request session token, and one or more measurement setup identifiers corresponding to the SBP request. The SBP responder identifies a measurement result reported by the sensing signal receiver by the measurement setup identifiers to correspond to the 2-tuple composed of the identifier of the corresponding SBP requester and the sensing proxy request session token, and indicates the identifier of the SBP responder, the identifier of the SBP requester, and the sensing proxy request session token in reporting the measurement result to the SBP requester. The SBP requester further saves a corresponding relationship of information provided in calling a SME by an upper-layer application run therein and one or more sensing proxy request session tokens, such that the measurement result is accurately reported to the upper-layer application.

FIG. 20 is an example of a response frame to a first request frame according to some embodiments of the present disclosure.

As shown in FIG. 20, the response frame to the first request frame is determined as a new action frame or an action no ack frame. The response frame to the first request frame includes a MAC frame header and a MAC frame body, and both the MAC frame header and the MAC frame body include a plurality of fields. The plurality of fields in the MAC frame body include action fields, and the action fields include one or more fields.

Illustratively, the action field includes an Action Category field and a Sensing Action Sub-category field.

The Action Category field indicates that the response frame to the first request frame is a sensing action frame. For example, the response frame to the first request frame is the sensing action frame in the case that a value carried in the Action Category field is 38.

The Sensing Action Sub-category field indicates that the response frame to the first request frame is an SBP response frame. For example, the response frame to the first request frame is the SBP response frame in the case that a value carried in the Sensing Action Sub-category field is 4 (any value in the range of 0 to 255).

It should be understood that fields subsequent to the Sensing Action Sub-category field is the same as the fields subsequent to the Public Action Sub-category field shown in FIG. 19, which are not repeated herein.

In some embodiments, in the case that the at least one measurement setup includes a plurality of measurement setups, the response frame to the first request frame includes a plurality of Response Info fields corresponding to the plurality of measurement setups. For example, the plurality of measurement setups are in one-to-one correspondence with the plurality of Response Info fields.

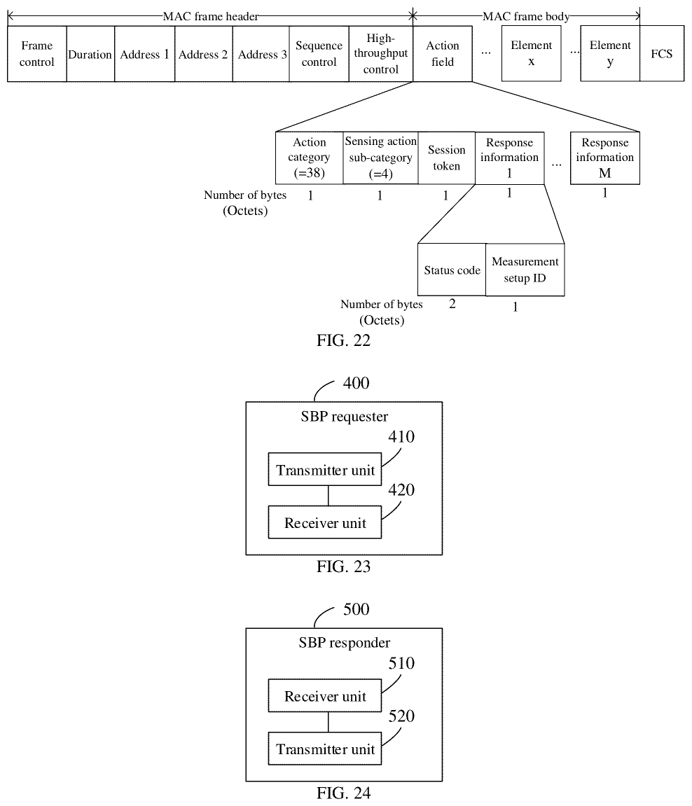

FIGS. 21 and 22 are examples of a response frame including a plurality of Response Info fields according to some embodiments of the present disclosure.

As shown in FIG. 21, on the basis of the structure of the response frame to the first request frame shown in FIG. 19, the response frame to the first request frame includes M Response Info fields, and the M Response Info fields are respectively configured to feed back the M measurement setups. As shown in FIG. 22, on the basis of the structure of the first request frame shown in FIG. 20, the response frame to the first request frame includes M Response Info fields, and the M Response Info fields are respectively configured to feed back the M measurement setups.

The embodiments of the present disclosure are described in detail in combination with the accompanying drawings. However, the present disclosure is not limited to specific details of the above embodiments. Various simple variations of the technical solutions of the present disclosure can be acquired within the scope of the technical conception of the present disclosure, and these simple variations are within the scope of protection of the present disclosure. For example, the specific technical features described in the above embodiments can be combined in any suitable way without contradiction. In order to avoid unnecessary repetition, various possible combinations are not described in the present disclosure. For example, any combination of different embodiments of the present disclosure can be made, as long as it does not contradict the concept of the present disclosure, which are also regarded as the content disclosed in the present disclosure.

It should be understood that in the embodiments of the present disclosure, the sequence number of the above processes does not mean the execution order, which shall be determined by its function and internal logic and shall not constructed as a limitation of the implementation process of the embodiments of the present disclosure. In addition, in the embodiments of the present disclosure, the term “and/or” herein describes associations between associated objects, and indicates three types of relationships. For example, “A and/or B” indicates that A alone, A and B, or B alone. In addition, the character “/” generally indicates that the associated objects are in an “or” relationship.

The method embodiments of the present disclosure are described in detail in combination with FIG. 3 to FIG. 22, and the device embodiments of the present disclosure are described hereinafter in combination with FIG. 23 to FIG. 26.

FIG. 23 is a schematic structural diagram of an SBP requester 400 according to some embodiments of the present disclosure.

As shown in FIG. 23, the SBP requester 400 includes:
a transmitter unit 410, configured to transmit a first request frame to an SBP responder, wherein the first request frame is configured to instruct the SBP responder to establish at least one measurement setup; and
a receiver unit 420, configured to receive a response frame to the first request frame from the SBP responder.

In some embodiments, the first request frame includes a first Action Category field and a first Public Action Sub-category field, wherein the first Action Category field indicates that the first request frame is a public action frame, and the first Public Action Sub-category field indicates that the first request frame is an SBP request frame.

In some embodiments, the first request frame includes a second Action Category field and a first Sensing Action Sub-category field, wherein the second Action Category field indicates that the first request frame is a sensing action frame, and the first Sensing Action Sub-category field indicates that the first request frame is an SBP request frame.

In some embodiments, the first request frame includes a Sensing Requirement Info field corresponding to a first measurement setup in the at least one measurement setup, wherein the Sensing Requirement Info field is configured for the SBP responder to establish the first measurement setup.

In some embodiments, the Sensing Requirement Info field includes a Measurement Participant field indicating whether the SBP requester participates in the at least one measurement setup.

In some embodiments, the Sensing Requirement Info field includes an Immediate Report field indicating whether a sensing signal receiver immediately reports measurement results acquired based on the at least one measurement setup.

In some embodiments, the Sensing Requirement Info field includes a Proxy Report Scheme field indicating a report scheme by which the SBP responder reports measurement results acquired based on the at least one measurement setup to the SBP requester.

In some embodiments, the at least one measurement setup includes a plurality of measurement setups, and the Sensing Requirement Info field includes an Element ID field indicating an identifier of the Sensing Requirement Info field.

In some embodiments, the Sensing Requirement Info field includes a Scheduling Info field configured to schedule a plurality of proxy devices to establish the first measurement setup, wherein the plurality of proxy devices include the SBP responder.

In some embodiments, the Scheduling Info field is configured to determine a start time of a first measurement instance based on the first measurement setup.

In some embodiments, the plurality of proxy devices include a first proxy device associated with the SBP requester, and the Scheduling Info field indicates an offset of a start time at which the first proxy device initiates the first measurement instance relative to a time at which the first proxy device receives the first request frame.

In some embodiments, the transmitter unit 410 is further configured to:
transmit update information to the plurality of proxy devices, wherein the update information is configured to update the start time of the first measurement instance.

In some embodiments, the Sensing Requirement Info field includes at least one of:
a Control field, indicating whether the Sensing Requirement Info field includes a field indicating a measurement requirement corresponding to the first measurement setup;
a Trigger Frame-based field, indicating whether a measurement procedure of the first measurement setup is triggered by a trigger frame; or
a Measurement Result Type field, indicating a type of a first measurement result acquired based on the first measurement setup.

In some embodiments, the Sensing Requirement Info field includes at least one of:
a Use Case Type field, indicating a required use case type for a sensing measurement based on the first measurement setup;
a Range Accuracy field, indicating a required range accuracy for the first measurement result;
a Velocity Accuracy field, indicating a required velocity accuracy for the first measurement result;
an Angular Accuracy field, indicating a required angular accuracy for the first measurement result;
a Measurement Frequency field, indicating a required measurement frequency for the sensing measurement based on the first measurement setup;
a Sensing Duration field, indicating a required duration for the sensing measurement based on the first measurement setup;
a Number of Sensing Responders field, indicating a number of sensing responders in the sensing measurement based on the first measurement setup; or
a Sensing Responder List field, indicating information of the sensing responders in the sensing measurement based on the first measurement setup.

In some embodiments, the type of the first measurement result includes at least one of:
CSI, a beam SNR, a TCIR, a TPDP, CSI amplitude only information, CSI phase only information, an AoA of a signal, or an AoD of the signal.

In some embodiments, the response frame to the first request frame includes a third Action Category field and a second Public Action Sub-category field, wherein the third Action Category field indicates that the response frame to the first request frame is a public action frame, and the second Public Action Sub-category field indicates that the response frame to the first request frame is an SBP response frame.

In some embodiments, the response frame to the first request frame includes a fourth Action Category field and a second Sensing Action Sub-category field, wherein the fourth Action Category field indicates that the response frame to the first request frame is a sensing action frame, and the second Sensing Action Sub-category field indicates that the response frame to the first request frame is an SBP response frame.

In some embodiments, the response frame to the first request frame includes a Response Info field corresponding to a second measurement setup in the at least one measurement setup, wherein the Response Info field indicates that the SBP responder rejects establishing the second measurement setup, or the Response Info field is configured for the SBP requester to determine an application corresponding to a second measurement result acquired based on the second measurement setup.

In some embodiments, the response frame to the first request frame includes a Status Code field indicating that the SBP responder establishes or rejects establishing the second measurement setup.

In some embodiments, in the case that the Status Code field indicates that the SBP responder rejects establishing the second measurement setup, the Status Code field further indicates a reason for rejecting establishing the second measurement setup.

In some embodiments, in the case that the Status Code field indicates that the SBP responder accepts a request for establishing the second measurement setup, the Response Info field further includes a Measurement Setup ID field indicating an identifier of the second measurement setup; and the transmitter unit 410 is further configured to:
report the second measurement result to an application corresponding to the identifier of the second measurement setup in the SBP requester.

In some embodiments, in the case that the Status Code field indicates that the SBP responder accepts a request for establishing the second measurement setup, the response frame to the first request frame further includes a session token corresponding to an identifier of the second measurement setup; and the transmitter unit 410 is further configured to:
report the second measurement result to an application corresponding to the session token in the SBP requester.

It should be understood that the device embodiments correspond to the method embodiments, and for similar descriptions, references may be made to the method embodiments. Specifically, the SBP requester 400 shown in FIG. 23 corresponds to the corresponding subject performing the method 200 or 300 in the embodiments of the present disclosure, and above and other operations and/or functions of various units in the SBP requester 400 perform corresponding processes in the methods in FIG. 3 or FIG. 4, which are not repeated herein for simplicity.

FIG. 24 is a schematic structural diagram of an SBP responder 500 according to some embodiments of the present disclosure.

As shown in FIG. 24, the SBP responder 500 includes:
a receiver unit 510, configured to receive a first request frame from an SBP requester, wherein the first request frame is configured to instruct the SBP responder to establish at least one measurement setup; and
a transmitter unit 520, configured to transmit a response frame to the first request frame to the SBP requester.

In some embodiments, the first request frame includes a first Action Category field and a first Public Action Sub-category field, wherein the first Action Category field indicates that the first request frame is a public action frame, and the first Public Action Sub-category field indicates that the first request frame is an SBP request frame.

In some embodiments, the first request frame includes a second Action Category field and a first Sensing Action Sub-category field, wherein the second Action Category field indicates that the first request frame is a sensing action frame, and the first Sensing Action Sub-category field indicates that the first request frame is an SBP request frame.

In some embodiments, the first request frame includes a Sensing Requirement Info field corresponding to a first measurement setup in the at least one measurement setup, wherein the Sensing Requirement Info field is configured for the SBP responder to establish the first measurement setup.

In some embodiments, the Sensing Requirement Info field includes a Measurement Participant field indicating whether the SBP requester participates in the at least one measurement setup.

In some embodiments, the Sensing Requirement Info field includes an Immediate Report field indicating whether a sensing signal receiver immediately reports measurement results acquired based on the at least one measurement setup.

In some embodiments, the Sensing Requirement Info field includes a Proxy Report Scheme field indicating a report scheme by which the SBP responder reports measurement results acquired based on the at least one measurement setup to the SBP requester.

In some embodiments, the at least one measurement setup includes a plurality of measurement setups, and the Sensing Requirement Info field includes an Element ID field indicating an identifier of the Sensing Requirement Info field.

In some embodiments, the Sensing Requirement Info field includes a Scheduling Info field configured to schedule a plurality of proxy devices to establish the first measurement setup, wherein the plurality of proxy devices include the SBP responder.

In some embodiments, the Scheduling Info field is configured to determine a start time of a first measurement instance based on the first measurement setup.

In some embodiments, the plurality of proxy devices include a first proxy device associated with the SBP requester, and the Scheduling Info field indicates an offset of a start time at which the first proxy device initiates the first measurement instance relative to a time at which the first proxy device receives the first request frame.

In some embodiments, the receiver unit 510 is further configured to:
receive update information from the SBP requester, wherein the update information is configured to update the start time of the first measurement instance.

In some embodiments, the Sensing Requirement Info field includes at least one of:
a Control field, indicating whether the Sensing Requirement Info field includes a field indicating a measurement requirement corresponding to the first measurement setup;
a Trigger Frame-based field, indicating whether a measurement procedure of the first measurement setup is triggered by a trigger frame; or
a Measurement Result Type field, indicating a type of a first measurement result acquired based on the first measurement setup.

In some embodiments, the Sensing Requirement Info field includes at least one of:
a Use Case Type field, indicating a required use case type for a sensing measurement based on the first measurement setup;
a Range Accuracy field, indicating a required range accuracy for the first measurement result;
a Velocity Accuracy field, indicating a required velocity accuracy for the first measurement result;
an Angular Accuracy field, indicating a required angular accuracy for the first measurement result;
a Measurement Frequency field, indicating a required measurement frequency for the sensing measurement based on the first measurement setup;
a Sensing Duration field, indicating a required duration for the sensing measurement based on the first measurement setup;
a Number of Sensing Responders field, indicating a number of sensing responders in the sensing measurement based on the first measurement setup; or
a Sensing Responder List field, indicating information of the sensing responders in the

sensing measurement based on the first measurement setup.

In some embodiments, the type of the first measurement result includes at least one of:
CSI, a beam SNR, a TCIR, a TPDP, CSI amplitude only information, CSI phase only information, an AoA of a signal, or an AoD of a signal.

In some embodiments, the response frame to the first request frame includes a third Action Category field and a second Public Action Sub-category field, wherein the third Action Category field indicates that the response frame to the first request frame is a public action frame, and the second Public Action Sub-category field indicates that the response frame to the first request frame is an SBP response frame.

In some embodiments, the response frame to the first request frame includes a fourth Action Category field and a second Sensing Action Sub-category field, wherein the fourth Action Category field indicates that the response frame to the first request frame is a sensing action frame, and the second Sensing Action Sub-category field indicates that the response frame to the first request frame is an SBP response frame.

In some embodiments, the response frame to the first request frame includes a Response Info field corresponding to a second measurement setup in the at least one measurement setup, wherein the Response Info field indicates that the SBP responder rejects establishing the second measurement setup, or the Response Info field is configured for the SBP requester to determine an application corresponding to a second measurement result acquired based on the second measurement setup.

In some embodiments, the response frame to the first request frame includes a Status Code field indicating that the SBP responder to establishes or rejects establishing the second measurement setup.

In some embodiments, in the case that the Status Code field indicates that the SBP responder rejects establishing the second measurement setup, the Status Code field further indicates a reason for rejecting establishing the second measurement setup.

In some embodiments, in the case that the Status Code field indicates that the SBP responder accepts a request for establishing the second measurement setup, the Response Info field further includes a Measurement Setup ID field indicating an identifier of the second measurement setup, and the identifier of the second measurement setup is configured for the SBP requester to determine an application corresponding to the identifier of the second measurement setup.

In some embodiments, in the case that the Status Code field indicates that the SBP responder accepts a request for establishing the second measurement setup, the response frame to the first request frame further includes a session token corresponding to an identifier of the second measurement setup, and the session token is configured for the SBP requester to determine an application corresponding to the session token.

It should be understood that the device embodiments correspond to the method embodiments, and for similar descriptions, references may be made to the method embodiments. Specifically, the SBP responder 500 shown in FIG. 24 corresponds to the corresponding subject performing the method 200 or 300 in the embodiments of the present disclosure, and above and other operations and/or functions of various units in the SBP responder 500 perform corresponding processes in the methods in FIG. 3 or FIG. 4, which are not repeated herein for simplicity.

The communication device in the embodiments of the present disclosure is described above from the perspective of functional modules in combination with the accompanying drawings. It should be understood that the functional module can be achieved in a hardware form, by instructions in a software form, and by a combination of hardware and software modules. In particular, processes in the method embodiments of the present disclosure can be performed by an integrated logic circuit in the hardware of the processor and/or instructions in the software form, processes of the method in embodiments of the present disclosure can be directly performed by the hardware decoding processor, or by a combination of hardware and software modules in the decoding processor. In some embodiments, software modules are disposed in the random access memory (RAM), a flash memory, a read-only memory, a programmable read-only memory, an electrically erasable programmable memory, a register and other mature storage medium in the field. The storage medium is disposed in the memory, and the processor reads the information in the memory and performs the processes in the above method embodiments in combination with the hardware.

For example, functions of the receiver unit 410, the receiver unit 420, the receiver unit 510, or the transmitter unit 520 are implemented by a transceiver.

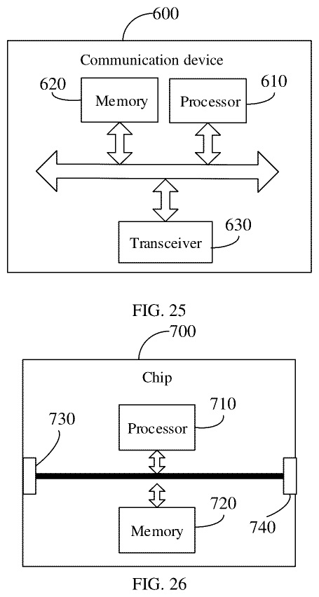

FIG. 25 is a schematic structural diagram of a communication device 600 according to some embodiments of the present disclosure.

As shown in FIG. 25, the communication device 600 includes a processor 610.

The processor 610, when loading and running computer programs stored in the memory, is caused to perform the method in the embodiments of the present disclosure.

As shown in FIG. 25, the communication device 600 further includes a memory 620.

The memory 620 is configured to store indication information, and codes, instructions, and the like executable by the processor 610. The processor 610, when loading and running computer programs stored in the memory 620, is caused to perform the method in the embodiments of the present disclosure. The memory 620 is a separate device from the processor 610 or is integrated in the processor 610.

As shown in FIG. 25, the communication device 600 further includes a transceiver 630.

The processor 610 controls communications of the transceiver 630 and other devices. In particular, the transceiver 630 transmits information or data to other devices, or receives information or data from other devices. The transceiver 630 includes a transmitter and a receiver. The transceiver 630 further includes one or more antennas.

It should be understood that various assemblies in the communication device 600 are connected with each other by a bus system. The bus system includes a data bus, a power bus, a control bus, a status signal bus, and the like.

It should be understood that the communication device 600 is the SBP requester in the embodiments of the present disclosure, and is capable of achieving corresponding procedures achieved by the SBP requester in the methods in the embodiments of the present disclosure. That is, the communication device 600 in the embodiments of the present disclosure corresponds to the SBP requester 400 in the embodiments of the present disclosure, and corresponds to the corresponding subject performing the method 200 or 300 in the embodiments of the present disclosure, which are not repeated herein for simplicity. Similarly, the communication device 600 is the SBP responder in the embodiments of the present disclosure, and is capable of achieving corresponding procedures achieved by the SBP responder in the methods in the embodiments of the present disclosure. That is, the communication device 600 in the embodiments of the present disclosure corresponds to the SBP responder 500 in the embodiments of the present disclosure, and corresponds to the corresponding subject performing the method 200 or 300 in the embodiments of the present disclosure, which are not repeated herein for simplicity.

In addition, the embodiments of the present disclosure further provide a chip.

For example, the chip is an integrated circuit chip with a signal processing capability, and achieves or performs the methods, processes, and logical blocks in the embodiments of the present disclosure. The chip is also referred to as a system-level chip, a system chip, a chip system, a system-on-chip, or the like. In some embodiments, the chip is applicable to various communication devices, such that the communication device equipped with the chip performs the methods, processes, and logical blocks in the embodiments of the present disclosure.

FIG. 26 is a schematic structural diagram of a chip 700 according to some embodiments of the present disclosure.

As shown in FIG. 26, the chip 700 includes a processor 710.

The processor 710, when calling and running computer programs stored in the memory, is caused to perform the method in the embodiments of the present disclosure.

As shown in FIG. 26, the chip 700 further includes a memory 720.

The processor 710, when calling and running computer programs stored in the memory 720, is caused to perform the method in the embodiments of the present disclosure. The memory 720 is configured to store indication information, and codes, instructions, and the like executable by the processor 710. The memory 720 is a separate device from the processor 710 or is integrated in the processor 710.

As shown in FIG. 26, the chip 700 further includes an input interface 730.

The processor 710 controls communications of the input interface 730 and other devices or chips. In particular, the processor 710 acquires information or data from other devices or chips.

As shown in FIG. 26, the chip 700 further includes an output interface 740.

The processor 710 controls communications of the output interface 740 and other devices or chips. In particular, the processor 710 outputs information or data to other devices or chips.

It should be understood that the chip 700 is applicable to the SBP requester or the SBP responder in the embodiments of the present disclosure. That is, the chip is capable of achieving corresponding procedures achieved by the SBP requester in the methods in the embodiments of the present disclosure and corresponding procedures achieved by the SBP responder in the methods in the embodiments of the present disclosure, which are not repeated herein for simplicity. It should be understood that various assemblies in the chip 700 are connected with each other by a bus system. The bus system includes a data bus, a power bus, a control bus, a status signal bus, and the like.

The processor in the above embodiments includes, but is not limited to:
a general purpose processor, a digital signal processor (DSP), an application specific integrated circuit (ASIC), a field programmable gate array (FPGA), other programmable logic devices, a discrete gate, a transistor logic device, a discrete hardware assembly, and the like.

The processor achieves or performs the methods, processes, and logical blocks in the embodiments of the present disclosure. The processes of the method in embodiments of the present disclosure can be directly performed by the hardware decoding processor, or by a combination of hardware and software modules in the decoding processor. The software modules are disposed in the random access memory, a flash memory, a read-only memory, a programmable read-only memory, an electrically erasable programmable memory, a register and other mature storage medium in the field. The storage medium is disposed in the memory, and the processor reads the information in the memory and performs the processes in the above method embodiments in combination with the hardware.

The memory in the above embodiments includes, but is not limited to:
a volatile memory and/or non-volatile memory. The non-volatile memory is a read-only memory (ROM), a programmable ROM (PROM), an erasable PROM (EPROM), an electrically EPROM (EEPROM), or a flash memory. The volatile memory is a RAM used as an external cache. By way of example but not limitation, various forms of RAMs are applied, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM).

It should be noted that the memory described herein is intended to include these and any other suitable type of memories.

Some embodiments of the present disclosure further provide a computer-readable storage medium. The computer-readable storage medium is configured to store computer programs. The computer-readable storage medium stores one or more programs, and the one or more programs include instructions. The instructions, when loaded and executed by a portable electronic device including a plurality of applications, cause the portable electronic device to perform the sensing method in the present disclosure. In some embodiments, the computer-readable storage medium is applicable to the SBP requester in the embodiments of the present disclosure, and the computer programs cause the computer to perform corresponding procedures achieved by the SBP requester in the methods in the embodiments of the present disclosure, which are not repeated herein for simplicity. In some embodiments, the computer-readable storage medium is applicable to the SBP responder in the embodiments of the present disclosure, and the computer programs cause the computer to perform corresponding procedures achieved by the SBP responder in the methods in the embodiments of the present disclosure, which are not repeated herein for simplicity.

Some embodiments of the present disclosure further provide a computer program product. The computer program product includes computer programs. In some embodiments, the computer program product is applicable to the SBP requester in the embodiments of the present disclosure, and the computer programs cause the computer to perform corresponding procedures achieved by the SBP requester in the methods in the embodiments of the present disclosure, which are not repeated herein for simplicity. In some embodiments, the computer program product is applicable to the SBP responder in the embodiments of the present disclosure, and the computer programs cause the computer to perform corresponding procedures achieved by the SBP responder in the methods in the embodiments of the present disclosure, which are not repeated herein for simplicity.

Some embodiments of the present disclosure further provide a computer program. The computer program, when loaded and run by a computer, causes the computer to perform the sensing method in the present disclosure. In some embodiments, the computer program is applicable to the SBP requester in the embodiments of the present disclosure, and the computer program, when loaded and run by the computer, causes the computer to perform corresponding procedures achieved by the SBP requester in the methods in the embodiments of the present disclosure, which are not repeated herein for simplicity. In some embodiments, the computer program is applicable to the SBP responder in the embodiments of the present disclosure, and the computer program, when loaded and run by the computer, causes the computer to perform corresponding procedures achieved by the SBP responder in the methods in the embodiments of the present disclosure, which are not repeated herein for simplicity.

Some embodiments of the present disclosure further provide a communication system. The communication system includes the above terminal device and the above SBP requester to form the communication system 100 shown in FIG. 1, which are not repeated herein for simplicity. It should be noted that the term “system” and the like herein are also referred to as a “network management architecture,” “system network,” or the like.

It should also be understood that the terms used in the embodiments of the present disclosure and the accompanied claims are only for the purpose of describing specific embodiments and are not intended to limit the embodiments of the present disclosure. For example, the singular terms “a,” “the,” “above,” and “that” used in the embodiments of the present disclosure and the accompanied claims are also intended to include the majority form, unless the context clearly indicates other meanings.

It should be understood by persons skilled in the art that the units and algorithmic processes of the examples described in conjunction with the embodiments herein can be achieved in electronic hardware, or a combination of computer software and electronic hardware. Whether the functions are achieved in hardware or software depends on the specific application and design constraints of the technical solutions. Technical professionals may use different methods to achieve the described functions for each specific application, but the implementation should not beyond the scope of the embodiments of the present disclosure. In the case that the function is achieved in the form of a software functional unit and sold or used as a stand-alone product, it can be stored in a computer-readable storage medium. Based on the understanding, the nature of the technical solutions of the embodiments of the present disclosure, the part contributing to some practices, or the part of the technical solutions can be manifested in the form of a software product, and the computer software products is stored in a storage medium and includes several instructions to cause a computer device (a personal computer, a server, a network device, or the like) to perform all or part of the processes of the methods in the embodiments of the present disclosure. The above storage medium include: a U disk, a mobile hard disk, a read-only memory, a random access memory, a disk, an optical disc, and other medium that can store program codes.

It should be understood by persons skilled in the art for convenience and simplicity of the descriptions, the detailed operating processes of the systems, devices, and units may be referred to the corresponding processes in the above method embodiments, which are not repeated herein. In the embodiments in the present disclosure, it should be understood that the disclosed systems, devices and methods may be achieved by other means. For example, the division of units, modules or assemblies in the above device embodiments is only a logical function division, and there can be another division method in actual implementation. For example, several units, modules or assemblies can be combined or integrated into another system, or some units, modules or assemblies can be ignored or not performed. For example, the above units/modules/assemblies as separate/display assemblies may or may not be physically separated, that is, disposed in one location, or distributed in several network units. Some or all of the units/modules/assemblies are selected according to the actual needs to achieve the purpose of the embodiments of the present disclosure. Finally, it should be noted that the coupling, the direct coupling or the communication connection between each other shown or discussed above may be indirect coupling or communication connection through some interface, devices or units, may be electrical, mechanical or in other form.

Described above are merely exemplary embodiments of the present disclosure, but the scope of protection of the embodiments of the present disclosure is not limited to the above description. Any variations and replacements readily derived by persons skilled in the art within the technical scope disclosed in the present disclosure shall fall within the scope of protection of the present disclosure. Therefore, the scope of protection of the present disclosure is subject to the appended claims.

1. A sensing method, applicable to a sensing by proxy (SBP) requester, the method comprising:
transmitting a first request frame to an SBP responder, wherein the first request frame is configured to instruct the SBP responder to establish at least one measurement setup, and the first request frame comprises a Sensing Requirement Info field corresponding to a first measurement setup in the at least one measurement setup, wherein the Sensing Requirement Info field is configured for the SBP responder to establish the first measurement setup; and
receiving a response frame to the first request frame from the SBP responder.

2. The method according to claim 1, wherein the Sensing Requirement Info field comprises a Measurement Participant field indicating whether the SBP requester participates in the at least one measurement setup.

3. The method according to claim 1, wherein the Sensing Requirement Info field comprises a Scheduling Info field configured to schedule a plurality of proxy devices to establish the first measurement setup, wherein the plurality of proxy devices comprise the SBP responder.

4. The method according to claim 1, wherein the Sensing Requirement Info field comprises at least one of:
a Use Case Type field, indicating a required use case type for a sensing measurement based on the first measurement setup;
a Range Accuracy field, indicating a required range accuracy for a first measurement result acquired based on the first measurement setup;
a Velocity Accuracy field, indicating a required velocity accuracy for the first measurement result;
an Angular Accuracy field, indicating a required angular accuracy for the first measurement result;
a Measurement Frequency field, indicating a required measurement frequency for the sensing measurement based on the first measurement setup;
a Sensing Duration field, indicating a required duration for the sensing measurement based on the first measurement setup;
a Number of Sensing Responders field, indicating a number of sensing responders in the sensing measurement based on the first measurement setup; or
a Sensing Responder List field, indicating information of the sensing responders in the sensing measurement based on the first measurement setup.

5. The method according to claim 1, wherein the response frame to the first request frame comprises a Status Code field indicating that the SBP responder establishes or rejects establishing a second measurement setup in the at least one measurement setup.

6. The method according to claim 5, wherein in a case that the Status Code field indicates that the SBP responder rejects establishing the second measurement setup, the Status Code field further indicates a reason for rejecting establishing the second measurement setup.

7. The method according to claim 5, wherein
in a case that the Status Code field indicates that the SBP responder accepts a request for establishing the second measurement setup, the Response Info field further comprises a Measurement Setup ID field indicating an identifier of the second measurement setup; and
the method further comprises:
reporting a second measurement result acquired based on the second measurement setup to an application corresponding to the identifier of the second measurement setup in the SBP requester.

8. A sensing by proxy (SBP) requester, comprising: a processor and a memory, wherein the memory is configured to store one or more computer programs, wherein the processor, when calling and running the one or more computer programs stored in the memory, causes the SBP requester to:
transmit a first request frame to an SBP responder, wherein the first request frame is configured to instruct the SBP responder to establish at least one measurement setup, and the first request frame comprises a Sensing Requirement Info field corresponding to a first measurement setup in the at least one measurement setup, wherein the Sensing Requirement Info field is configured for the SBP responder to establish the first measurement setup; and
receive a response frame to the first request frame from the SBP responder.

9. The SBP requester according to claim 8, wherein the Sensing Requirement Info field comprises a Measurement Participant field indicating whether the SBP requester participates in the at least one measurement setup.

10. The SBP requester according to claim 8, wherein the Sensing Requirement Info field comprises a Scheduling Info field configured to schedule a plurality of proxy devices to establish the first measurement setup, wherein the plurality of proxy devices comprise the SBP responder.

11. The SBP requester according to claim 8, wherein the Sensing Requirement Info field comprises at least one of:
a Use Case Type field, indicating a required use case type for a sensing measurement based on the first measurement setup;
a Range Accuracy field, indicating a required range accuracy for a first measurement result acquired based on the first measurement setup;
a Velocity Accuracy field, indicating a required velocity accuracy for the first measurement result;
an Angular Accuracy field, indicating a required angular accuracy for the first measurement result;
a Measurement Frequency field, indicating a required measurement frequency for the sensing measurement based on the first measurement setup;
a Sensing Duration field, indicating a required duration for the sensing measurement based on the first measurement setup;
a Number of Sensing Responders field, indicating a number of sensing responders in the sensing measurement based on the first measurement setup; or
a Sensing Responder List field, indicating information of the sensing responders in the sensing measurement based on the first measurement setup.

12. The SBP requester according to claim 8, wherein the response frame to the first request frame comprises a Status Code field indicating that the SBP responder establishes or rejects establishing a second measurement setup in the at least one measurement setup.

13. The SBP requester according to claim 12, wherein in a case that the Status Code field indicates that the SBP responder rejects establishing the second measurement setup, the Status Code field further indicates a reason for rejecting establishing the second measurement setup.

14. The SBP requester according to claim 12, wherein
in a case that the Status Code field indicates that the SBP responder accepts a request for establishing the second measurement setup, the Response Info field further comprises a Measurement Setup ID field indicating an identifier of the second measurement setup; and
the processor, when calling and running the one or more computer programs stored in the memory, further causes the SBP requester to:
report a second measurement result acquired based on the second measurement setup to an application corresponding to the identifier of the second measurement setup in the SBP requester.

15. A sensing by proxy (SBP) responder, comprising: a processor and a memory, wherein the memory is configured to store one or more computer programs, wherein the processor, when calling and running the one or more computer programs stored in the memory, causes the SBP responder to:
receive a first request frame from an SBP requester, wherein the first request frame is configured to instruct the SBP responder to establish at least one measurement setup, and the first request frame comprises a Sensing Requirement Info field corresponding to a first measurement setup in the at least one measurement setup, wherein the Sensing Requirement Info field is configured for the SBP responder to establish the first measurement setup; and
transmit a response frame to the first request frame to the SBP requester.

16. The SBP responder according to claim 15, wherein the Sensing Requirement Info field comprises a Measurement Participant field indicating whether the SBP requester participates in the at least one measurement setup.

17. The SBP responder according to claim 15, wherein the Sensing Requirement Info field comprises a Scheduling Info field configured to schedule a plurality of proxy devices to establish the first measurement setup, wherein the plurality of proxy devices comprise the SBP responder.

18. The SBP responder according to claim 15, wherein the Sensing Requirement Info field comprises at least one of:
a Use Case Type field, indicating a required use case type for a sensing measurement based on the first measurement setup;
a Range Accuracy field, indicating a required range accuracy for a first measurement result acquired based on the first measurement setup;
a Velocity Accuracy field, indicating a required velocity accuracy for the first measurement result;
an Angular Accuracy field, indicating a required angular accuracy for the first measurement result;
a Measurement Frequency field, indicating a required measurement frequency for the sensing measurement based on the first measurement setup;
a Sensing Duration field, indicating a required duration for the sensing measurement based on the first measurement setup;
a Number of Sensing Responders field, indicating a number of sensing responders in the sensing measurement based on the first measurement setup; or
a Sensing Responder List field, indicating information of the sensing responders in the sensing measurement based on the first measurement setup.

19. A chip, comprising: a processor, wherein the processor, when loading and running one or more computer programs in a memory, causes a device equipped with the chip to perform the method as defined in claim 1.

20. A non-transitory computer-readable storage medium, storing one or more computer programs therein, wherein the one or more computer programs, when loaded and run by a computer, cause the computer to perform the method as defined in claim 1.
